(19) United States
(12) Patent Application Publication
(10) Pub. No.: US 2026/0131512 A1
(43) Pub. Date: May 14, 2026

(54) METHODS AND SYSTEMS FOR FORMING THREE-DIMENSIONAL ARTICLES

(71) Applicant: 3D Systems, Inc., Rock Hill, SC (US)

(72) Inventors: Diego MARTINEZ, Rock Hill, SC (US); Jordan MILLER, Rock Hill, SC (US); Bagrat GRIGORYAN, Rock Hill, SC (US); Pingyong XU, Rock Hill, SC (US); Anna Kristen MAI, Rock Hill, SC (US); Monica KEILSOHN, Rock Hill, SC (US)

(21) Appl. No.: 19/386,988

(22) Filed: Nov. 12, 2025

Related U.S. Application Data
(60) Provisional application No. 63/719,350, filed on Nov. 12, 2024.

(51) Int. Cl. B29C 45/44; B29C 45/26; B33Y 80/00; C08F 222/10; C08L 89/00; C09D 135/02

(52) U.S. Cl. CPC B29C 45/4457; B29C 45/26; C08F 222/1063; C08L 89/00; C09D 135/02; B29K 2833/08; B29K 2833/26; B29K 2995/0059; B33Y 80/00; C08F 2800/20

(57) ABSTRACT

In one aspect, methods for forming three-dimensional articles are described. In some embodiments, a method described herein comprises providing a first mold, wherein the first mold comprises an interior volume, and injecting a first fluid material into the interior volume of the first mold. The method further comprises solidifying the injected first fluid material within the interior volume of the first mold to form a solidified object.

### CROSS REFERENCE TO RELATED APPLICATIONS

This application claims priority pursuant to 35 U.S.C. § 119 to U.S. Provisional Patent Application No. 63/719,350, filed Nov. 12, 2024, which is hereby incorporated by reference in its entirety.

### FIELD

The present disclosure relates to methods and systems for forming three-dimensional (3D) articles, including for molding applications.

### BACKGROUND

Articles and molds with features measuring on the micron and nanometer scale are difficult to manufacture. Currently, techniques to produce such articles and molds are limited. Specifically, articles with such characteristics for biological applications are challenging. Therefore, there exists a need for new methods appropriate for forming 3D articles and molds with high resolution and fine features for biological applications.

### SUMMARY

In one aspect, methods of forming a 3D article are described herein. Such methods described herein, in some cases, can be used to provide 3D articles useful for molding applications. However, 3D articles formed by methods described herein may be used in other ways and for other end uses, and the use of a 3D article formed by a method described herein is not necessarily limited.

In some embodiments, a method described herein comprises providing a first mold, wherein the first mold comprises, defines, or has an interior volume. In some instances, providing the first mold comprises placing a first mold in a chamber. Additionally, in some such cases, the chamber comprises one or more injection ports for injecting a first fluid material into the interior volume of the first mold. Further, in some implementations, the first mold comprises, defines, or has one or more receiving ports for receiving the first fluid material into the interior volume of the mold, from the one or more injection ports of the chamber. Moreover, the one or more receiving ports of the first mold can be in fluid communication with the one or more injection ports of the chamber, as described further herein. In addition, in some embodiments, a method described herein further comprises pressurizing the chamber, and injecting the first fluid material through the one or more injection ports through the one or more receiving ports and into the interior volume of the first mold. Moreover, in some implementations, the chamber is pressurized to a pressure greater than 1 atmosphere (atm). In some preferred embodiments, the chamber is pressurized to a pressure greater than an injection pressure of the first fluid material into the interior volume of the first mold. Additionally, in some such cases, pressurizing the chamber comprises pressurizing the chamber to a pressure less than a crack pressure threshold of the first mold.

It is also possible to inject the first fluid material into the interior volume of the first mold without using a chamber, injection port, and/or receiving port as described above. Additionally, a method described herein, in some embodiments, further comprises solidifying the injected fluid material within the interior volume of the mold to form a solidified object. Moreover, a method described herein, in some cases, can further comprise removing the first mold from the solidified object (e.g., by dissolving or melting the first mold, or mechanically removing the first mold from the solidified object).

In some embodiments, the solidified object formed as described above is the final 3D article formed by a method described herein. However, in some implementations, the method further comprises carrying out additional steps to form the final 3D article. For example, in some cases, a method described here further comprises modifying the exterior surface of the solidified object described above. In some such cases, modifying the exterior surface of the solidified object comprises roughening or smoothing the exterior surface or coating the exterior surface, such as by dip coating, electroplating the exterior surface, or a combination thereof.

Moreover, in some cases, the solidified object may itself be used as a positive mold for further molding steps. Thus, in some such embodiments, a method described herein further comprises applying a second fluid material to the exterior surface of the solidified object, and solidifying the second fluid material on the exterior surface of the solidified object to form a second mold. It is to be understood that this second mold is generally a mold of the solidified object. Additionally, in some cases, the method further comprises removing the solidified object from the second fluid material. For example, the solidified object could be dissolved or melted or otherwise removed, “leaving behind” the second mold. In this manner, a second mold (that is, a mold of the exterior surface of the “original” solidified object) can be provided for further use.

In another aspect, 3D articles are described herein. Such 3D articles may be formed using any method, any system, and/or any composition or material described herein. In some embodiments, such a three-dimensional article forms or defines a vascular network or topology. For example, in some embodiments, the solidified object of a method described herein forms or defines a vascular network or topology.

In still another aspect, systems for forming a 3D article are provided. In some embodiments, a system described herein comprises a chamber comprising one or more injection ports, wherein the chamber is pressurized or operable to be pressurized, including in a manner described above. In some cases, a system described herein further comprises a first mold comprising an interior volume and one or more receiving ports. In some implementations, the system further comprises a first fluid material to inject through the one or more injection ports through the one or more receiving ports and into the interior volume of the first mold.

These and other embodiments are further described in the detailed description which follows.

### BRIEF DESCRIPTION OF THE DRAWINGS

FIG. 1 illustrates a block diagram of steps of a method according to one embodiment described herein.

FIG. 2A illustrates a perspective view of a 3D printed mold, according to one embodiment described herein.

FIG. 2B illustrates a perspective view of the 3D printed mold of FIG. 2A filled with a first fluid material that has solidified to yield a solidified object, according to one embodiment described herein.

FIG. 2C illustrates a perspective view of the solidified object of FIG. 2B with the mold removed, according to one embodiment described herein.

FIG. 2D illustrates a perspective view of the solidified object of FIG. 2C surrounded by a second fluid material, according to one embodiment described herein.

FIG. 2E illustrates a perspective view of a second mold formed from the second fluid material of FIG. 2D, according to one embodiment described herein.

FIG. 2F illustrates a perspective view of a second mold formed from the second fluid material of FIG. 2D, according to one embodiment described herein.

### DETAILED DESCRIPTION

Embodiments described herein can be understood more readily by reference to the following detailed description, examples, and figures. Elements, apparatus, and methods described herein, however, are not limited to the specific embodiments presented in the detailed description, examples, and figures. It should be recognized that these embodiments are merely illustrative of the principles of the present disclosure. Numerous modifications and adaptations will be readily apparent to those of skill in the art without departing from the spirit and scope of the disclosure.

In addition, all ranges disclosed herein are to be understood to encompass any and all subranges subsumed therein. For example, a stated range of “1.0 to 10.0” should be considered to include any and all subranges beginning with a minimum value of 1.0 or more and ending with a maximum value of 10.0 or less, e.g., 1.0 to 5.3, 1 to 4, 3 to 7, 4.7 to 10.0, 3.6 to 7.9, or 5 to 8.

All ranges disclosed herein are also to be considered to include the end points of the range, unless expressly stated otherwise. For example, a range of “between 5 and 10,” “from 5 to 10,” or “5-10” should generally be considered to include the end points 5 and 10.

Further, when the phrase “up to” is used in connection with an amount or quantity, it is to be understood that the amount is at least a detectable amount or quantity (that is, the amount is a non-zero amount). For example, a material present in an amount “up to” a specified amount can be present from a detectable (or non-zero) amount and up to and including the specified amount.

It is also to be understood that the article “a” or “an” refers to “at least one,” unless the context of a particular use requires otherwise.

The terms “three-dimensional printing system,” “three-dimensional printer,” “printing,” and the like generally describe various solid freeform fabrication techniques for making 3D articles or objects by stereolithography (SLA), digital light processing (DLP), selective deposition, jetting, fused deposition modeling (FDM), multi-jet modeling (MJM) or multi-jet printing (MJP), and other additive manufacturing techniques now known in the art or that may be known in the future that use a build material to fabricate three-dimensional objects.

### I. Methods of Forming a Three-Dimensional Article

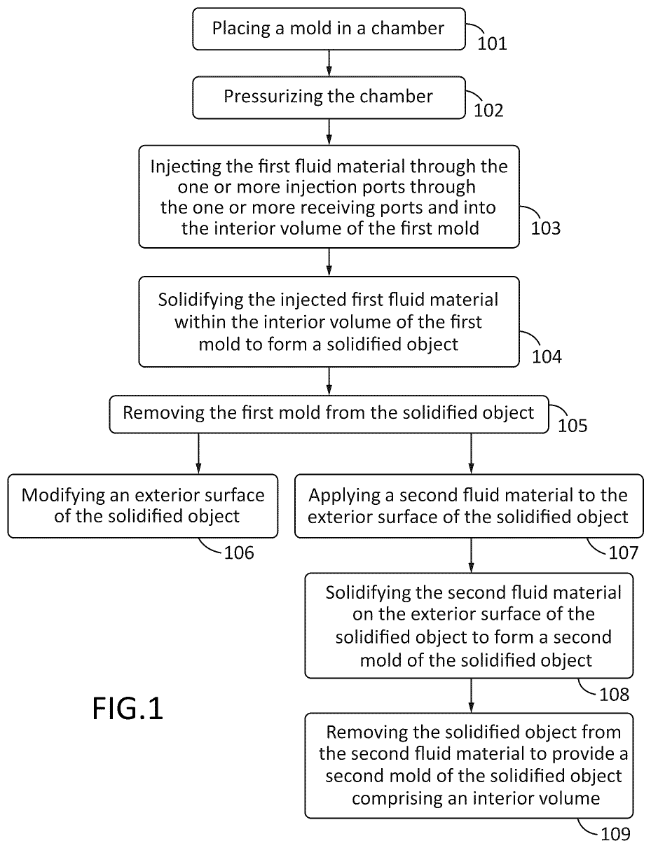

In one aspect, methods of forming a 3D article are described herein. Certain features may be shown in reference to the figures. As shown in FIG. 1, in some embodiments, a method described herein comprises placing a first mold in a chamber (step 101), wherein the first mold comprises, defines, or has an interior volume. As understood by the person of ordinary skill in the field, a “mold” in this context generally is hollow, and the cavity or hollow portion (e.g., the interior volume described herein) provides shape to a fluid material disposed in the mold, which can harden or solidify within the mold. Moreover, as understood by the person of ordinary skill in the field, the solidified material can have a shape that is determined by (or “matches”) the shape of the interior volume of the mold.

In some cases, the chamber of a method described herein comprises one or more injection ports for injecting a first fluid material into the interior volume of the first mold (e.g., as further described herein). In some implementations, the first mold comprises, defines, or has one or more receiving ports for receiving the first fluid material into the interior volume of the mold, from the one or more injection ports of the chamber (e.g., as described further herein). In some embodiments, the method further comprises pressurizing the chamber (step 102), injecting the first fluid material through the one or more injection ports through the one or more receiving ports and into the interior volume of the first mold (step 103), and solidifying the injected fluid material within the interior volume of the mold to form a solidified object (step 104). In some cases, the method further comprises removing the first mold from the solidified object (step 105). In some embodiments, the solidified object is the final three-dimensional article formed by a method described herein. However, in some implementations, the exterior surface of the final solidified object may be modified (step 106). In some cases, modifying the exterior surface of the solidified object comprises roughening or smoothing the surface of the solidified object, coating the exterior surface of the solidified object, or any combination thereof.

Alternatively, in some cases, after the removal of the first mold, the solidified object may be treated as a positive mold. Thus, in some instances, the method further comprises applying a second fluid material to the exterior surface of the solidified object (step 107) and solidifying the second fluid material on the exterior surface of the solidified object to form a second mold of the solidified object (step 108). Moreover, in such cases, the method further comprises removing the solidified object from the second fluid material to provide a second mold of the solidified object comprising an interior volume (step 109). For example, in some implementations, the solidified object could be dissolved, melted, or otherwise removed, “leaving behind” the second mold. In this manner, a second mold (that is, a mold of the exterior surface of the “original” solidified object) can be provided for further use. In this context, as understood by a person of ordinary skill in the field, such a “mold” has a shape (e.g., a generally hollow shape) that is determined by (or “matches) the object of which the mold is a mold.

It is further to be understood that one or more specific steps depicted in the non-limiting example method of FIG. 1 may be omitted if desired. Other steps may also be included, other than those shown in FIG. 1. For example, in some instances, step 101 and/or step 102 is omitted. That is, in some cases, the first mold is not necessarily placed within a chamber, or the chamber is not necessarily pressurized. It is to be understood that “pressuring” a chamber as described herein comprises more than simply allowing the chamber to have whatever ambient pressure may otherwise naturally occur in the chamber, without an intentional act of modifying the pressure (generally, by increasing the pressure). Likewise, as understood by one of ordinary skill in the art, the chamber of a method described herein can generally be a container that is able to be pressurized as described herein, while maintaining the desired pressure for an appropriate length of time, sufficient for carrying out the method. For example, in some cases, the chamber used in a method described herein is a metal, fiberglass, or glass container, vessel, box, or other enclosure that can be pressurized as described herein within rupturing, and that can maintain the desired pressure (e.g., within 5% or less) for at least 30 minutes, at least one hour, at least two hours, at least five hours, or at least 24 hours.

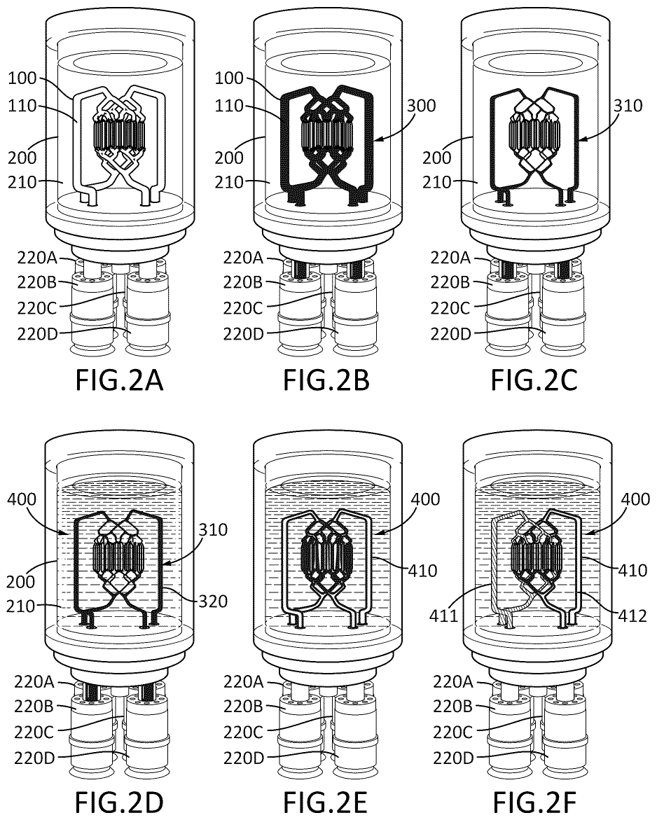

Turning again to the figures, an exemplary embodiment of a method described herein is shown in FIG. 2. In FIG. 2A, a 3D printed first mold (100) is shown in the interior volume (210) of a chamber (200). The chamber (200) has a plurality of vertically oriented injection ports (220A-D). The injection ports (220A-D) are for receiving a first fluid material (300) into the interior volume (110) of the first mold (100).

In FIG. 2B, for visualization purposes, the first fluid material (300) is depicted in black. Moreover, the entirety of the first mold (100) filled with the first fluid material (300) is depicted in black. However, it is to be understood that the first mold (100) has a non-zero wall thickness, such that the first fluid material (300) is confined within an interior volume (110) of the first mold (100), as will be appreciated by the person of ordinary skill in the field. Thus, as illustrated in FIG. 2B, after optionally pressurizing the chamber (200), the first fluid material (300) is injected into the first mold (100) through one or more injection ports (e.g., 220B and 220D) and into the interior volume (110) of the first mold (100). Subsequent to this injection, the first fluid material (300) is solidified to form a solidified object (310), as illustrated in FIG. 2C.

In FIG. 2C, the first mold (100) has been removed through one or more of the injection ports (e.g., 220B and 220D) to yield or reveal the solidified object (310), which is formed from solidification of the first fluid material (300) inside the interior volume (110) of the first mold (100). It should be noted that the solidified object (310) in FIG. 2C has the same general size and shape as the interior volume (110) of the first mold (100). However, due to the non-zero thickness of the walls of the first mold (100), the solidified object (310) is of course smaller than the first mold (100), as seen in FIGS. 2B and 2C when comparing the sizes of the portions of these figures depicted in black.

In FIG. 2D, a second fluid material (400) has been applied to the exterior surface (320) of the solidified object (310) within the chamber (200). The second fluid material (400) conforms to the exterior surface (320) of the solidified object (310). Thus, upon solidification of the second fluid material (400), the second fluid material (400) forms or defines a second mold (410) of the solidified object (310), as shown in FIG. 2E. In FIG. 2E, the solidified object (310) has been removed from the chamber (200) to reveal the second mold (410) of the solidified object (310).

FIG. 2F shows the same second mold (410) as in FIG. 2E, except with hatching added to further illustrate the morphology of the second mold (410), in this specific embodiment. As illustrated in FIG. 2E and FIG. 2F, the second mold (410) forms or defines two independent fluid networks (411, 412). For illustration purposes, a first fluid network (411) is illustrated with hatching, and a second fluid network (412) is illustrated without hatching. Each of the fluid networks (411, 412) can be accessed via a pair of injection ports (220A-D). For example, the first fluid network (411) can be accessed via a first pair of injection ports (220A, 220B), and the second fluid network (412) can be accessed via a second pair of injection ports (220C, 220D). Each pair of injection ports (220A/220B as the first pair, and 220C/220D as the second pair) can form an independent fluid ‘circuit’ with the second mold (410), where each ‘circuit’ is not fluidically mixed with the ‘circuit’ formed by the other pair of injection ports and the other fluid network of the second mold (410).

Turning to components of the first mold, the material of the first mold can be any material not inconsistent with the technical objectives of the present disclosure. In some implementations, the first mold comprises, consists of, consists essentially of, or is formed from a hydrogel, a wax, a plastic, polyvinyl alcohol, poly(ethylene glycol) (PEG), PEG-norbornene, MMP-sensitive PEGs, gelatin methacrylate, or any combination thereof.

In some preferred embodiments, the first mold comprises, consists of, consists essentially of, or is formed from a hydrogel. As understood by one of ordinary skill in the art, a “hydrogel” can be considered to be a gel in which the liquid component is water or water-based. The hydrogel may comprise any material not inconsistent with the technical objectives of the present disclosure. In some embodiments, the hydrogel may comprise alginate. In some such embodiments, the hydrogel may comprise alginate crosslinked with calcium chloride. In some implementations, the hydrogel comprises a compound having the structure of Formula (I) and/or a compound having the structure of Formula (II):

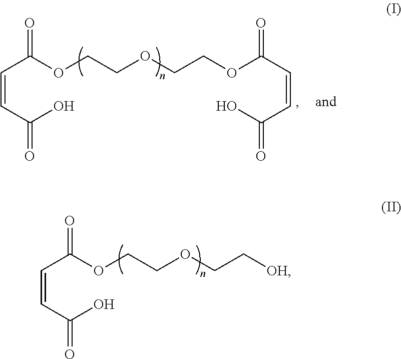

wherein n is an integer between 4 and 40. In some cases, n is an integer between 4 and 14, between 4 and 20, between 6 and 30, between 10 and 40, or between 10 and 20. Other values of n are also possible. Moreover, it is to be understood that a species of Formula (I) can be referred to as “MA-PEG#-MA,” where “#” is the approximate weight average molecular weight of the poly(ethylene glycol) or “PEG” portion of the compound. For example, “MA-PEG200-MA” refers to a compound of Formula (I) wherein n has a value corresponding to a PEG moiety having a molecular weight of about 200. Similarly, it is to be understood that a species of Formula (II) can be referred to as “MA-PEG#,” where “#” is the approximate weight average molecular weight of the PEG portion of the compound.

The compound having the structure of Formula (I) and/or the compound having the structure of Formula (II) can be present in a hydrogel described herein in any amount not inconsistent with the technical objectives of the present disclosure. In some cases, the compound having the structure of Formula (I) and/or the compound having the structure of Formula (II) is present in an amount of 10-35 wt. %, based on the total weight of the hydrogel. In some cases, the compound having the structure of Formula (I) and/or the compound having the structure of Formula (II) is present in an amount of 10-30 wt. %, 10-25 wt. %, 10-20 wt. %, 10-15 wt. %, 15-35 wt. %, 15-30 wt. %, 15-25 wt. %, 15-20 wt. %, 20-35 wt. %, 20-30 wt. %, 20-25 wt. %, 25-35 wt. %, 25-30 wt. %, or 30-35 wt. % based on the total weight of the hydrogel.

Moreover, in some implementations, the hydrogel comprises or further comprises a monomeric curable material having the structure of Formula (III):

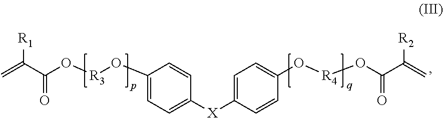

wherein the sum of p and q is an integer between 2 and 30, wherein R₁ and R₂ are each independently H or CH₃, wherein R₃ and R₄ are each independently a C₁-C₄ alkyl, and
wherein X is a linear or branched C₁-C₄ alkyl or a group with the structure:

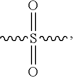

wherein [symbol] represents a point of attachment to the remainder of the structure of Formula (III). In some instances, in Formula (III), X is C(CH₃)₂. In other cases, in Formula (III), X is CH₂. Non-limiting examples of monomeric curable material for use in some embodiments of a hydrogel described herein include ethoxylated (10) bisphenol A diacrylate and ethoxylated (30) bisphenol A diacrylate.

For reference purposes herein, it is to be understood that a “Cₙ-Cₘ alkyl moiety” (e.g., a “C₁-C₄ alkyl moiety”) is a bivalent saturated aliphatic radical having from “n” to “m” carbon atoms (e.g., 1 to 4 carbon atoms, and no more than 4 carbon atoms). Moreover, a “C” moiety in this context has exactly “n” carbon atoms (no more, no less). It is further to be understood that the “n” and “m” may be subscripted or not subscripted, without changing the meaning (e.g., “C₁-Cₘ” may sometimes be written as “Cn-Cm” instead). Similarly, in the present disclosure a Cn-Cm “alkyl” moiety may be referred to as an “alkylene” moiety. It will be appreciated by a person of ordinary skill in the art that these terms may be used interchangeably in this context, in view of the relevant principles of chemistry.

In general, the monomeric curable material can be present in a hydrogel described herein in any amount not inconsistent with the technical objectives of the present disclosure. In some embodiments, the monomeric curable material is present in an amount of 30-50 wt. %, 30-45 wt. %, 30-40 wt. %, 30-35 wt. %, 35-50 wt. %, 35-45 wt. %, 35-40 wt. %, 40-50 wt. %, 40-45 wt. %, or 45-50 wt. %, based on the total weight of the hydrogel.

Additionally, in some embodiments, a hydrogel described herein may further comprise an acrylate or acrylamide component. In general, the acrylate or acrylamide component of a hydrogel described herein can be present in the hydrogel in any amount not inconsistent with the technical objectives of the present disclosure. In some instances, the acrylate or acrylamide component is present in an amount of 25-50 wt. %, 25-45 wt. %, 25-40 wt. %, 25-35 wt. %, 25-30 wt. %, 30-50 wt. %, 30-45 wt. %, 30-40 wt. % 30-35 wt. %, 35-50 wt. %, 35-45 wt. %, 35-40 wt. %, 40-50 wt. %, 40-45 wt. %, or 45-50 wt. % based on the total weight of the hydrogel.

Moreover, in some implementations, the acrylate or acrylamide component comprises one or more (meth)acrylates. It is to be understood that the term “(meth)acrylate” includes an acrylate or a methacrylate or a mixture or combination thereof. Additionally, in some cases, a (meth)acrylate comprises a (meth)acrylate monomer, a (meth)acrylate oligomer, or a mixture thereof.

Further, a (meth)acrylate monomer and/or a (meth)acrylate oligomer described herein can comprise a monofunctional, difunctional, trifunctional, tetrafunctional, pentafunctional, or higher functional (meth)acrylate species. A “monofunctional” (meth)acrylate species, for reference purposes herein, comprises a chemical species that includes one (meth)acrylate moiety. Similarly, a “difunctional” (meth)acrylate species comprises a chemical species that includes two (meth)acrylate moieties; a “trifunctional” (meth)acrylate species comprises a chemical species that includes three (meth)acrylate moieties; a “tetrafunctional” (meth)acrylate species comprises a chemical species that includes four (meth)acrylate moieties; and a “pentafunctional” (meth)acrylate species comprises a chemical species that includes five (meth)acrylate moieties. Thus, in some embodiments, a monofunctional (meth)acrylate component of a hydrogel described herein comprises a mono(meth)acrylate, a difunctional (meth)acrylate component of a hydrogel described herein comprises a di(meth)acrylate, a trifunctional (meth)acrylate component of a hydrogel described herein comprises a tri(meth)acrylate, a tetrafunctional (meth)acrylate component of a hydrogel described herein comprises a tetra(meth)acrylate, and a pentafunctional (meth)acrylate component of a hydrogel described herein comprises a penta(meth)acrylate. Other (meth)acrylate species may also be used.

Moreover, a (meth)acrylate species (such as a monofunctional, difunctional, trifunctional, tetrafunctional, or pentafunctional (meth)acrylate species), in some cases, can comprise or be a relatively low molecular weight species, i.e., a “monomeric” (meth)acrylate or (meth)acrylate “monomer” (where a “monomer” or “monomeric” species is generally a species having a molecular weight below 300, below 200, or below 100), or a relatively high molecular weight species, i.e., an “oligomeric” (meth)acrylate or (meth)acrylate “oligomer” (where an “oligomer” or “oligomeric” species is generally a species having a molecular weight above 300, above 400, above 500, or above 600, and optionally below 10,000, where it is understood that the molecular weight may be a weight average molecular weight in the case of an oligomer or oligomeric species having a molecular weight distribution). Additionally, in some embodiments, a (meth)acrylate “monomer” has a viscosity of 500 centipoise (cP) or less at 25° C., when measured according to ASTM D2983 (2022 version), while a (meth)acrylate “oligomer” has a viscosity of 1000 cP or more at 25° C., when measured according to ASTM D2983.

As stated above, a hydrogel described herein can comprise a (meth)acrylate monomer. The (meth)acrylate monomer can comprise any (meth)acrylate monomer not inconsistent with the objectives of the present disclosure. In some cases, for instance, the (meth)acrylate monomer comprises one or more hydrophilic or water soluble (meth)acrylates. A “water soluble” species or material, for reference purposes herein, has a solubility in water (or in an acidic or basic aqueous solution described further herein) of at least 1 gram per 1 liter of water (or of aqueous solution) at 25° C. In some cases, a water soluble species or material has a solubility of at least 5 g/L, at least 10 g/L, or at least 100 g/L at 25° C.

In some embodiments described herein, the (meth)acrylate monomer comprises hydrophilic or water soluble mono-, di-, and/or tri(meth)acrylate species. The (meth)acrylate monomer, for example, can comprise one or more of hydroxylalkyl(meth)acrylates (e.g., hydroxypropylacrylate), ethoxylated trimethylol propane triacrylate (“TAC” or trimethylolpropane ethoxylate triacrylate), and various combinations or mixtures thereof. In some embodiments, hydroxyalkyl(meth)acrylates include hydroxyethyl(meth)acrylate, hydroxypropyl(meth)acrylate, hydroxybutyl(meth)acrylate, and/or mixtures thereof. In some implementations, the (meth)acrylate comprises carboxyethyl acrylate, hydroxypropyl acrylate, acrylic acid, or a mixture thereof.

Additionally, in some cases, the (meth)acrylate monomer of a hydrogel described herein comprises a cyclocarbonate (meth)acrylate monomer. In some such instances, the cyclocarbonate (meth)acrylate monomer has the structure of Formula (IV):

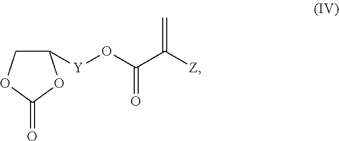

wherein Y is a linear or branched C₁-C₆ alkylene moiety; and
wherein Z is H or CH₃.

For reference purposes herein (as previously noted above), it is to be understood that a “Cₙ-Cₘ alkylene moiety” (e.g., a “C₁-C₄ alkylene moiety”) is a bivalent saturated aliphatic radical having from “n” to “m” carbon atoms (e.g., 1 to 4 carbon atoms, and no more than 4 carbon atoms). In some preferred embodiments, Y is a linear or branched C₁-C₄ alkylene moiety, such as CH₂, which is especially preferred. Additionally, in some embodiments, Z is H. Further, in some instances, Y is CH₂ and Z is H. Thus, in some cases, the cyclocarbonate (meth)acrylate monomer of a hydrogel described herein has the structure of Formula (V):

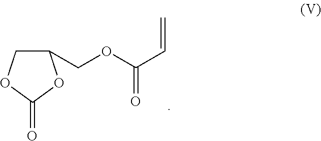

It is to be understood that the (meth)acrylate monomer of a hydrogel described herein can include a combination of monomeric species, such as a combination of two or more of the monomeric (meth)acrylate species described above. For example, in some cases, the (meth)acrylate monomer comprises one or more hydroxyalkyl(meth)acrylates, one or more poly(ethylene glycol) (meth)acrylates (of sufficiently low molecular weight), one or more poly(ethylene glycol) di(meth)acrylates (of sufficiently low molecular weight), one or more cyclocarbonate (meth)acrylates, or a combination of two or more of the foregoing. Thus, the present disclosure contemplates many combinations and compositions of (meth)acrylate monomers that can be included in example implementations, though they are not explicitly enumerated herein.

Hydrogels described herein, in some embodiments, may also comprise a (meth)acrylate oligomer. Any (meth)acrylate oligomer species not inconsistent with the technical objectives of the present disclosure may be used. In some preferred embodiments, the (meth)acrylate oligomer comprises one or more hydrolysable oligomeric species. A “hydrolysable” oligomeric species, for reference purposes herein, includes at least one hydrolysable bond. In some cases, the hydrolysable bond is part of the repeating unit of the oligomer. For example, in some instances, a hydrolysable oligomeric species comprises one or more urethane bonds, one or more ester bonds, or one or more carbonate bonds in the backbone of the oligomeric species. As understood by one of ordinary skill in the art, such a bond may be hydrolyzed by water, including in a relatively facile manner when exposed to water or an aqueous solution described herein for a time period and at a temperature described herein.

Moreover, in some embodiments, a (meth)acrylate oligomer can be bifunctional or higher functional, as well as being hydrolysable. Additionally, in some embodiments, a majority of the total amount of the (meth)acrylate oligomer is bifunctional or higher functional. For example, in some cases, at least 60 wt. %, at least 70 wt. %, at least 80 wt. %, or at least 90 wt. % of the (meth)acrylate oligomer component is bifunctional or higher functional, where the foregoing weight percentages are based on the total amount of the (meth)acrylate oligomer component.

In some implementations, a (meth)acrylate oligomer of a hydrogel described herein comprises a poly(ethylene glycol) diacrylate (PEGDA) component. With reference to the poly(ethylene glycol) diacrylate component as used herein, the PEGDA component can comprise a single poly(ethylene glycol) diacrylate species or multiple poly(ethylene glycol) diacrylate species of differing molecular weights. In some embodiments, species of the PEGDA component have a weight average molecular weight of 0.1 kiloDalton (kDa) to 20 kDa, 0.2 to 20 kDa, or 0.1 to 35 kDa.

The molecular weight of individual species of PEGDA, for example, can fall within one or more ranges set forth in Table 1.

TABLE 1
Poly(ethylene glycol) Diacrylate Molecular Weight (kDa).
0.3-1
0.3-20
0.5-1
3-5
3-10
10-20
0.5-5
20-35

Any combination or mixture of poly(ethylene glycol) diacrylates of differing molecular weights is contemplated. In some cases, the PEGDA component comprises a mixture of two of more PEGDA species each having a weight average molecular weight from 0.5 to 5 kDa.

In some embodiments of a hydrogel described herein, a (meth)acrylate oligomer comprises a urethane acrylate oligomer, a urethane methacrylate oligomer, a polyether urethane oligomer, an aliphatic polyester urethane acrylate oligomer, or a combination of two or more of the foregoing. Additionally, in some cases, the (meth)acrylate oligomer can comprise an aliphatic urethane diacrylate oligomer.

Some non-limiting examples of commercially available (meth)acrylate oligomers useful in some embodiments described herein include the following: monofunctional urethane acrylate, commercially available from RAHN USA under the trade name GENOMER 1122; an aliphatic urethane diacrylate, commercially available from ALLNEX under the trade name EBECRYL 8402; an aliphatic urethane diacrylate oligomer, commercially available from IGM Resins under the trade name PHOTOMER 6210; an aliphatic urethane diacrylate oligomer, commercially available from IGM Resins under the trade name PHOTOMER 6710; a multifunctional acrylate oligomer, commercially available from DYMAX Corporation under the trade name BR-952; aliphatic polyether urethane acrylate, commercially available from DYMAX Corporation under the trade name BR-371S; and polyether urethane methacrylate, commercially available from DYMAX Corporation under the trade name BR-541 MD. Other commercially available oligomeric (meth)acrylates may also be used.

Urethane (meth)acrylates suitable for use in hydrogels described herein, in some cases, can be prepared in a known manner, typically by reacting a hydroxyl-terminated urethane with acrylic acid or methacrylic acid to give the corresponding urethane (meth)acrylate, or by reacting an isocyanate-terminated prepolymer with hydroxyalkyl acrylates or methacrylates to give the urethane (meth)acrylate. Suitable processes are disclosed, inter alia, in EP-A 114 982 and EP-A 133 908. The weight average molecular weight of such (meth)acrylate oligomers, in some cases, can be from about 500 to 6,000. Urethane (meth)acrylates are also commercially available from SARTOMER under the product names CN980, CN981, CN975 and CN2901. In some embodiments, urethane acrylate oligomers are employed in hydrogels described herein. Suitable urethane acrylates can include difunctional aliphatic urethane acrylates from DYMAX Corporation under the trade designations BR-741 and BR-970. In some embodiments, a (meth)acrylate oligomer comprises aliphatic polyester urethane acrylate or aliphatic polyether urethane acrylate. Commercial examples of these oligomeric species are available from DYMAX Corporation under the trade designations BR-7432 and BR-543, respectively.

In some instances, the acrylate or acrylamide component of a hydrogel described herein comprises one or more acrylamides. For reference purposes herein, it is to be understood that an “acrylamide” can comprise a chemical species comprising at least one acrylamide moiety or functional group. In some embodiments, the one or more acrylamides comprises dimethyl acrylamide, diethyl acrylamide, acryloyl morpholine, isopropyl acrylamide, dimethyl aminopropyl acrylamide, dimethyl aminopropyl acrylamide, hydroxyethyl acrylamide, or a mixture thereof.

In general, the one or more acrylamides can be present in a hydrogel described herein in any amount not inconsistent with the technical objectives of the present disclosure. In some cases, the one or more acrylamides is present in an amount of 10-40 wt. %, based on the total weight of the composition. In some instances, the one or more acrylamides is present in an amount of 10-35 wt. %, 10-30 wt. %, 10-25 wt. %, 10-20 wt. %, 10-15 wt. %, 15-40 wt. %, 15-35 wt. %, 15-30 wt. %, 15-25 wt. %, 15-20 wt. %, 20-40 wt. %, 20-35 wt. %, 20-30 wt. %, 20-25 wt. %, 25-40 wt. %, 25-35 wt. %, 25-30 wt. %, 30-40 wt. %, 30-35 wt. %, or 35-40 wt. %, based on the total weight of the composition of the hydrogel.

Turning to another possible component of a hydrogel described herein, hydrogels described herein can also comprise a photoinitiator component. Any photoinitiator not inconsistent with the objectives of the present disclosure may be used in a hydrogel described herein. In some embodiments, for example, the photoinitiator component comprises an alpha-cleavage type (unimolecular decomposition process) photoinitiator or a hydrogen abstraction photosensitizer-tertiary amine synergist, operable to absorb light between about 250 nm and about 400 nm, between about 250 nm and 405 nm, or between about 300 nm and about 385 nm, to yield free radical(s). Examples of alpha cleavage photoinitiators are Irgacure 184 (CAS 947-19-3), Irgacure 369 (CAS 119313-12-1), and Irgacure 819 (CAS 162881-26-7). An example of a photosensitizer-amine combination is Darocur BP (CAS 119-61-9) with diethylaminoethylmethacrylate.

In addition, in some instances, photoinitiators comprise benzoins, including benzoin, benzoin ethers, such as benzoin methyl ether, benzoin ethyl ether and benzoin isopropyl ether, benzoin phenyl ether and benzoin acetate, acetophenones, including acetophenone, 2,2-dimethoxyacetophenone and 1,1-dichloroacetophenone, benzil, benzil ketals, such as benzil dimethyl ketal and benzil diethyl ketal, anthraquinones, including 2-methylanthraquinone, 2-ethylanthraquinone, 2-tert-butylanthraquinone, 1-chloroanthraquinone and 2-amylanthraquinone, triphenylphosphine, benzoylphosphine oxides, such as 2,4,6-trimethylbenzoyldiphenylphosphine oxide (Lucirin TPO), benzophenones, such as benzophenone and 4,4′-bis(N,N′-dimethylamino)benzophenone, thioxanthones and xanthones, acridine derivatives, phenazine derivatives, quinoxaline derivatives or 1-phenyl-1,2-propanedione, 2-O-benzoyl oxime, 1-aminophenyl ketones or 1-hydroxyphenyl ketones, such as 1-hydroxycyclohexyl phenyl ketone, phenyl 1-hydroxyisopropyl ketone and 4-isopropylphenyl 1-hydroxyisopropyl ketone.

Suitable photoinitiators can also comprise photoinitiators operable for use with a HeCd laser radiation source, including acetophenones, 2,2-dialkoxybenzophenones and 1-hydroxyphenyl ketones, such as 1-hydroxycyclohexyl phenyl ketone or 2-hydroxyisopropyl phenyl ketone (=2-hydroxy-2,2-dimethylacetophenone). Additionally, in some cases, suitable photoinitiators comprise those operable for use with an Ar laser radiation source including benzil ketals, such as benzil dimethyl ketal. In some embodiments, a suitable photoinitiator comprises an α-hydroxyphenyl ketone, benzil dimethyl ketal or 2,4,6-trimethylbenzoyldiphenylphosphine oxide or a mixture thereof.

Another class of photoinitiators that may be included in a hydrogel described herein comprises ionic dye-counter ion compounds capable of absorbing actinic radiation and generating free radicals for polymerization initiation. In some embodiments, a hydrogel containing ionic dye-counter ion compounds can be polymerized upon exposure to visible light within the adjustable wavelength range of about 400 nm to about 700 nm. Ionic dye-counter ion compounds and their mode of operation are disclosed in EP-A-0 223 587 and U.S. Pat. Nos. 4,751,102; 4,772,530; and 4,772,541.

In some cases, a photoinitiator that may be included in a hydrogel described herein comprises a water-soluble pyrrolidone or phosphine oxide such as a monoacylphosphine oxide (MAPO) salt or bisacylphosphine oxide (BAPO) salt, which may in some instances be a sodium or lithium MAPO or BAPO salt. In some embodiments, a photoinitiator included in a composition of a hydrogel described herein has a structure of Formula (VI) or Formula (VII):

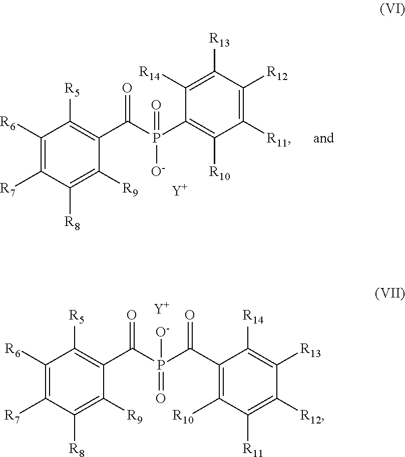

wherein Y is Na or Li, and wherein each of R₅-R₁₄ is independently H, CH₃, or CH₂CH₃. For example, in some preferred embodiments, each of R₅, R₇, and R₉ in Formula (VI) is CH₃, and each of R₆, R₈, R₁₀, R₁₁, R₁₂, R₁₃, and R₁₄ is H. Such a species can be referred to herein as “NaP”, “Na-TPO”, “Sodium TPO”, or “Sodium TPO-L” when Y is Na, and as “LiP”, “Li-TPO”, “Lithium TPO”, or “Lithium TPO-L” when Y is Li. In other preferred embodiments, each of R₅, R₇, R₉, R₁₀, R₁₂, and R₁₄ in Formula (VII) is CH₃, and each of R₆, R₈, R₉, and R₁₃ is H. Such a species can be referred to herein as BAPO—ONa when Y is Na, and as BAPO—OLi when Y is Li. It is further to be understood with reference to Formula (VI) and Formula (VII) above that these structures also represent resonance structures, or structures in which (for drawing convenience) the P—O single bond and the P—O double bond “switch places” in the depiction of the structure (e.g., such that the P—O double bond in Formula (VII) points “up” like the two adjacent C—O double bonds, rather than pointing “down” as depicted above).

A photoinitiator component can be present in a hydrogel described herein in any amount not inconsistent with the objectives of the present disclosure. In some embodiments, a photoinitiator component is present in a hydrogel described herein in an amount of up to about 7 wt. %, up to about 5 wt. %, up to about 3 wt. %, or up to about 2 wt. %, based on the total weight of the hydrogel. In some cases, a photoinitiator is present in an amount of about 0.1-7 wt. %, 0.1-5 wt. %, 0.1-3 wt. %, 0.1-2 wt. %, 0.5-5 wt. %, 0.5-3 wt. %, 0.5-2 wt. %, 1-7 wt. %, 1-5 wt. %, 1-3 wt. %, or 2-3 wt. %, based on the total weight of the hydrogel.

It is to be further understood that the amounts (weight percents) described in the immediately preceding paragraph refer to photoinitiators that are non-oligomeric and non-polymeric. That is, the amounts described above refer to “monomeric” or “molecular” photoinitiators, which may, for instance, have a molecular weight of less than 300 or less than 400. However, it is also to be understood that oligomeric or polymeric photoinitiators may be used in hydrogels described herein. But in such an instance (when an oligomeric or polymeric photoinitiator is used), then the amounts (weight percents) above are to be calculated without taking into account the weight of the oligomeric or polymeric portion or moiety of the oligomeric or polymeric photoinitiator. In other words, to determine the overall amount (weight percent) of the oligomeric or polymeric photoinitiator that is present in the hydrogel, the calculation (specifically, the numerator) should be based on only the molecular weight of the photoactive moiety of the photoinitiator, not on the molecular weight(s) of the remaining moieties or repeating units of the oligomeric or polymeric photoinitiator (for purposes of the present disclosure).

Moreover, in some instances, a hydrogel described herein can also comprise at least one colorant. Such a colorant of a hydrogel described herein can be a particulate colorant, such as a particulate pigment, or a molecular colorant, such as a molecular dye. Any such particulate or molecular colorant not inconsistent with the technical objectives of the present disclosure may be used. In some cases, for instance, the colorant of a hydrogel described herein comprises an inorganic pigment, such as TiO₂ and/or ZnO. In some embodiments, the colorant of a hydrogel comprises a colorant for use in a RGB, sRGB, CMY, CMYK, L*a*b*, or Pantone® colorization scheme. Moreover, in some cases, a particulate colorant described herein has an average particle size of less than about 5 μm, or less than about 1 μm. In some instances, a particulate colorant described herein has an average particle size of less than about 500 nm, such as an average particle size of less than about 400 nm, less than about 300 nm, less than about 250 nm, less than about 200 nm, or less than about 150 nm. In some instances, a particulate colorant has an average particle size of about 50-5000 nm, about 50-1000 nm, or about 50-500 nm.

A colorant can be present in a hydrogel described herein in any amount not inconsistent with the technical objectives of the present disclosure. In some cases, the colorant is present in the hydrogel in an amount up to about 2 wt. %, or an amount of about 0.005-2 wt. %, 0.01-2 wt. %, 0.01-1.5 wt. %, 0.01-1 wt. %, 0.01-0.5 wt. %, 0.1-2 wt. %, 0.1-1 wt. %, 0.1-0.5 wt. %, or 0.5-1.5 wt. %, based on the total weight of the hydrogel. In some embodiments, a hydrogel described herein excludes colorant as described above.

A hydrogel described herein may be formed, produced, made, or manufactured in any manner not inconsistent with the technical objectives of the present disclosure. In some embodiments, for instance, a method for the preparation of a hydrogel described herein comprises the steps of mixing the components of the hydrogel, optionally melting the mixture, and filtering the (optionally molten) mixture. In some cases, the components are mixed and optionally melted at a temperature between about 25° C. and about 35° C., or at a temperature in the range of 25-55° C., 35-65° C., or 45-75° C. In some instances in which it is desirable or necessary to melt one or more solid components of the composition, mixing and/or melting can be carried about a temperature in a range from about 75° C. to about 85° C. In some embodiments, a hydrogel described herein is produced by placing all components of the composition in a reaction vessel, optionally heating the resulting mixture, and stirring the resulting mixture at a temperature between about 25° C. and about 75° C. or a temperature ranging from about 75° C. to about 85° C. The stirring (and optionally the heating) are continued until the mixture attains a substantially homogenized liquid (or molten) state. In general, the liquid (or molten) mixture can be filtered while in a flowable state to remove any large undesirable particles that may interfere with jetting or extrusion or other printing process, such as if the hydrogel is to be formed into a mold described herein using additive manufacturing. In some such cases, the filtered mixture can then be cooled to ambient temperatures (if cooling is needed) and stored until ready for use in an additive manufacturing system.

Moreover, in some embodiments, a hydrogel is printed using a 3D printer or additive manufacturing system, as part of a method described herein. Thus, in some embodiments, a method described herein further comprises forming the hydrogel mold using additive manufacturing. Additive manufacturing methods of forming a mold described herein (from a hydrogel or otherwise) are further described below.

Turning to other possible materials of the first mold, in some cases, the first mold comprises, consists of, consists essentially of, or is formed from a wax. The wax can be any wax not inconsistent with the technical objectives of the present disclosure. In some embodiments, the wax can be a lipophilic and/or malleable solid near ambient temperature (e.g., 22-33° C.). In some implementations, the wax can include a lipid or higher alkane with a melting point above about 40° C. In some other cases, the wax may be insoluble in water but soluble in organic and/or nonpolar solvents.

In some cases, the wax used to form a first mold described herein can comprise an alkane. In some embodiments, the alkane comprises an alkane with the formula CH₃(CH₂)ₙCH₃, where n is an integer between 14 and 48. In some implementations, the alkane comprises hexadecane, heptadecane, octadecane, eicosane, heneicosane, docosane, tetracosane, nonacosane, triacontane, hentriacontane, dotriacontane, hexatriacontane, tetracontane, tetratetracontane, pentacontane, or mixtures thereof. In some cases, a wax comprises an alkene, and the alkene has the formula CH₃(CH₂)ₙCH═CH₂, where n is an integer between 14 and 48. In some embodiments, the alkene comprises 1-octadecene.

In some cases, a wax used to form a first mold described herein may comprise an unsaturated hydrocarbon fatty alcohol and/or a saturated hydrocarbon fatty alcohol. In some such implementations, for example, the saturated hydrocarbon fatty alcohol may comprise decyl alcohol, lauryl alcohol, myristyl alcohol, palmityl alcohol, stearyl alcohol, arachidyl alcohol, behenyl alcohol, lignoceryl alcohol, ceryl alcohol, myricyl alcohol, or a combination of two or more of the foregoing.

In still other cases, a wax used to form a first mold described herein comprises a lipid. In some implementations, a wax comprise a saturated fatty acid. In some embodiments, for instance, the saturated fatty acid has a formula CH₃(CH₂)ₙCOOH, wherein n is an integer between 4 and 30. An alkyl ester of such a fatty acid may also be used in some cases. In some embodiments, a wax comprises hexanoic acid, nonanoic acid, octanoic acid, decanoic acid, methyl nonadecanoate, lauric acid, methyl arachidate, myristic acid, methyl tricosanoate, methyl behenate, heptadecanoic acid, palmitic acid, stearic acid, melissic acid, or a combination of two or more of the foregoing. Additionally, in some implementations, a wax used to form a mold described herein comprise an unsaturated fatty acid. In some such cases, the unsaturated fatty acid may comprise arachidonic acid, linolenic acid, palmitoleic acid, oleic acid, or any combinations thereof. In some embodiments, a wax used to form a mold described herein may comprise a combination of a saturated fatty acid and an unsaturated fatty acid.

In some implementations, a wax described herein is plant derived, animal derived, petroleum derived, synthetic, or any combination thereof. In some cases, the wax comprises a paraffin, soy wax, beeswax, gulf wax, carnauba wax, candelilla wax, polyethylene wax, microcrystalline wax, or any combination thereof. In some embodiments, the wax further comprises an additive. Any additive not inconsistent with the technical objectives of the disclosure may be used. In some cases, the additive comprises stearic acid, glyceryl tristearate, sorbitan tristearate, lecithin, resins, dammar gum, mastic gum, copal gum, shellac, or combinations thereof. In some embodiments, additives may be used to enhance the mechanical properties of the wax. In some implementations, the wax can be diluted with peanut oil, sunflower oil, soybean oil canola oil, olive oil, rice bran oil, or any combination thereof.

It is to be understood that the first mold of a method or system described herein may be formed, produced, made, or manufactured in any manner not inconsistent with the technical objectives of the present disclosure. For example, as noted above, in some preferred embodiments the first mold is printed using a 3D printer. Thus, in some embodiments, a method described herein further comprises forming the first mold using additive manufacturing. In some such cases, a mold is formed from a plurality of layers of a hydrogel or other composition described herein in a layer-by-layer manner. Moreover, in such cases, the relevant composition (e.g., the hydrogel or wax) can be used as a build material. Methods of forming a mold by additive manufacturing can also include forming the object in a manner other than a layer-by-layer manner.

The use of additive manufacturing to form a mold (or other article) will now be described in further detail. In some cases, a method described herein comprises providing a build material comprising a mold composition described above (e.g., a hydrogel described above), and selectively curing a portion of the build material using incident curing radiation having a Gaussian distribution of wavelengths and a peak wavelength at the wavelength λ. Moreover, in some embodiments described herein, the build material is selectively cured according to a digital file or image of the desired article, such as according to preselected computer aided design (CAD) parameters or other digital parameters. Moreover, in some cases, one or more layers of a build material described herein has a thickness of about 10 μm to about 100 μm, about 10 μm to about 80 μm, about 10 μm to about 50 μm, about 10 μm to about 40 μm, about 20 μm to about 100 μm, about 20 μm to about 80 μm, or about 20 μm to about 40 μm. Other thicknesses are also possible.

Performing a printing process described herein can provide a printed 3D mold from a build material described herein that has a high feature resolution. The “feature resolution” of an article, for reference purposes herein, can be the smallest controllable physical feature size of the article or the pixel or voxel size of the printing process, where it is understood that “pixel” and “voxel” refer to the CAD parameter or other digital model of the mold. In some embodiments, a printed article (e.g., mold) described herein has an average voxel size greater than 50 μm per side on average (e.g., when the average voxel size corresponds to a volume having an average length in all three dimensions of 50-100 μm, 50-75 μm, 60-100 μm, 60-80 μm, or 60-70 μm). In other cases, a printed article (e.g.) described herein has an average voxel size of less than 50 μm, less than 40 μm, less than 30 μm, or less than 20 μm per side on average (e.g., when the average voxel size corresponds to a volume having an average length in all three dimensions of 10-45 μm, 10-40 μm, 10-30 μm, 10-25 μm, 10-20 μm, 15-45 μm, or 15-40 μm).

Additionally, it is to be understood that methods of printing a mold or other article (e.g., chamber) described herein can include, for example, MJP, DLP, or SLA 3D printing methods. For example, in some instances, a MJP method of printing a 3D article comprises selectively depositing layers of a build material described herein in a fluid state onto a substrate, such as a build pad of a 3D printing system. In addition, in some embodiments, a method described herein further comprises supporting at least one of the layers of the build material with a support material. Any support material not inconsistent with the objectives of the present disclosure may be used.

A method described herein can also comprise curing the layers of the build material, including with curing radiation described above (such as curing radiation having a peak wavelength λ). Moreover, curing can comprise polymerizing one or more polymerizable moieties or functional groups of one or more components of the build material. In some cases, a layer of deposited build material is cured prior to the deposition of another or adjacent layer of build material. Additionally, curing one or more layers of deposited build material, in some embodiments, is carried out by exposing the one or more layers to electromagnetic radiation, such as ultraviolet (UV) light, visible light, or infrared light, as described above.

It should further be noted that a wavelength λ used to cure a material according to a method described herein can be any wavelength not inconsistent with the objectives of the present disclosure. For example, in some cases, X is a wavelength in the ultraviolet (UV) or visible region of the electromagnetic spectrum. In some cases, the peak wavelength λ is in the infrared (IR) region of the electromagnetic spectrum. In some embodiments, the wavelength λ is between 250 nm and 400 nm, between 300 nm and 385 nm, or between 385 nm and 405 nm. In other cases, the wavelength λ is between 600 nm and 800 nm or between 900 nm and 1.3 μm. However, the precise wavelength λ is not particularly limited.

Further details regarding various additive manufacturing methods, including “material deposition” methods (such as MJP) or “vat polymerization” methods (such as SLA or DLP), are provided below.

In a material deposition method, one or more layers of a build material described herein are selectively deposited onto a substrate and cured. Curing of the build material may occur after selective deposition of one layer, each layer, several layers, or all layers of the build material.

In some instances, a build material described herein (e.g., a hydrogel composition described hereinabove) is selectively deposited in a fluid state onto a substrate, such as a build pad of a 3D printing system. Selective deposition may include, for example, depositing the build material according to preselected CAD parameters or other preselected parameters based on a digital file, image, or model of the desired article. For example, in some embodiments, a CAD file drawing corresponding to a desired 3D article to be printed is generated and sliced into a sufficient number of horizontal slices. Then, the build material is selectively deposited, layer by layer, according to the horizontal slices of the CAD file drawing to print the desired 3D article. A “sufficient” number of horizontal slices is the number necessary for successful printing of the desired 3D article, e.g., to produce it accurately and precisely.

Further, in some embodiments, a preselected amount of build material described herein is heated to the appropriate temperature and jetted through a print head or a plurality of print heads of a suitable inkjet printer to form a layer on a print pad in a print chamber. In some cases, each layer of build material is deposited according to preselected CAD parameters or other preselected parameters based on a digital file, image, or model of the desired article. A suitable print head to deposit the build material, in some embodiments, is a piezoelectric print head. Additional suitable print heads for the deposition of build material and support material described herein are commercially available from a variety of ink jet printing apparatus manufacturers. For example, Xerox, Hewlett Packard, or Ricoh print heads may be used in some instances.

Additionally, in some embodiments, a build material described herein remains substantially fluid upon deposition. Alternatively, in other instances, the build material exhibits a phase change upon deposition and/or solidifies upon deposition. Moreover, in some cases, the temperature of the printing environment can be controlled so that the jetted droplets of build material solidify on contact with the receiving surface. In other embodiments, the jetted droplets of build material do not solidify on contact with the receiving surface, remaining in a substantially fluid state. Additionally, in some instances, after each layer is deposited, the deposited material is planarized and cured with electromagnetic (e.g., UV, visible, or infrared light) radiation prior to the deposition of the next layer. Optionally, several layers can be deposited before planarization and curing, or multiple layers can be deposited and cured followed by one or more layers being deposited and then planarized without curing. Planarization corrects the thickness of one or more layers prior to curing the material by evening the dispensed material to remove excess material and create a uniformly smooth exposed or flat up-facing surface on the support platform of the printer. In some embodiments, planarization is accomplished with a wiper device, such as a roller, which may be counter-rotating in one or more printing directions but not counter-rotating in one or more other printing directions. In some cases, the wiper device comprises a roller and a wiper that removes excess material from the roller. Further, in some instances, the wiper device is heated. It should be noted that the consistency of the jetted build material described herein prior to curing, in some embodiments, should desirably be sufficient to retain its shape and not be subject to excessive viscous drag from the planarizer.

Moreover, a support material, when used, can be deposited in a manner consistent with that described hereinabove for the build material. The support material, for example, can be deposited according to the preselected CAD parameters (or other parameters described herein) such that the support material is adjacent or continuous with one or more layers of the build material. Jetted droplets of the support material, in some embodiments, solidify or freeze on contact with the receiving surface. In some cases, the deposited support material is also subjected to planarization, curing, or planarization and curing. Any support material not inconsistent with the objectives of the present disclosure may be used.

Layered deposition of the build material and support material can be repeated until the 3D article has been formed. In some embodiments, a method of forming a 3D article further comprises removing the support material from the build material. The support material can be removed in any manner not inconsistent with the technical objectives of the present disclosure. In some cases, for instance, removing the support material comprises melting the support material. In some such embodiments, the support material has a melting point that is at least 20° C., at least 30° C., at least 40° C., at least 50° C., at least 70° C., or at least 100° C. lower than a melting point, softening point, heat deflection temperature (HDT), or glass transition temperature (T_{g}) of the build material. In some such cases, the support material comprises or is formed from a wax. Moreover, in some preferred embodiments described herein, the support material is not removed by dissolving or dispersing the support material in water or using an aqueous solution described herein.

Curing of the build material may occur after selective deposition of one layer of build material, of each layer of build material, of several layers of build material, or of all layers of the build material necessary to print the desired 3D article. In some embodiments, a partial curing of the deposited build material is performed after selective deposition of one layer of build material, each layer of build material, several layers of build material, or all layers of the build material necessary to print the desired 3D article. A “partially cured” build material, for reference purposes herein, is one that can undergo further curing. For example, a partially cured build material is up to about 30% polymerized or cross-linked or up to about 50% polymerized or cross-linked. In some embodiments, a partially cured build material is up to about 60%, up to about 70%, up to about 80%, up to about 90%, or up to about 95% polymerized or cross-linked.

Partial curing of the deposited build material can include irradiating the build material with an electromagnetic radiation source or photocuring the build material (including with curing radiation described hereinabove). Any electromagnetic radiation source not inconsistent with the objectives of the present disclosure may be used, e.g., an electromagnetic radiation source that emits UV, visible or infrared light. For example, in some embodiments, the electromagnetic radiation source can be one that emits light having a wavelength from about 300 nm to about 900 nm, e.g., a Xe arc lamp.

Further, in some embodiments, a post-curing is performed after partially curing is performed. For example, in some cases, post-curing is carried out after selectively depositing all layers of the build material necessary to form a desired 3D article (e.g., a mold described herein), after partially curing all layers of the build material, or after both of the foregoing steps have been performed. Moreover, in some embodiments, post-curing comprises photocuring, including with curing radiation described hereinabove having a peak wavelength λ. Again, any electromagnetic radiation source not inconsistent with the objectives of the present disclosure may be used for a post-curing step described herein. For example, in some embodiments, the electromagnetic radiation source can be a light source that has a higher energy, a lower energy, or the same energy as the electromagnetic radiation source used for partial curing. In some cases wherein the electromagnetic radiation source used for post-curing has a higher energy (i.e., a shorter wavelength) than that used for partial curing, a Xe arc lamp can be used for partial curing and a Hg lamp can be used for post-curing.

Additionally, after post-curing, in some cases, the deposited layers of build material are at least about 80% polymerized or cross-linked or at least about 85% polymerized or cross-linked. In some embodiments, the deposited layers of build material are at least about 90%, at least about 95%, at least about 98%, or at least about 99% polymerized or cross-linked. In some instances, the deposited layers of build material are about 80-100%, about 80-99%, about 80-95%, about 85-100%, about 85-99%, about 85-95%, about 90-100%, or about 90-99% polymerized or cross-linked.

The degree of polymerization or cross-linking can be determined using any protocol or method not inconsistent with the technical objectives of the present disclosure, such as by determining the percentage of monomers incorporated into the polymer network (e.g., based on molecular weight of the polymer compared to the molecular weight of the monomer, or based on the total polymer mass compared to the theoretical maximum of the total polymer mass) or by determining the amount of unincorporated monomers. When more than one method is used to determine a degree of polymerization or cross-linking, the results of the methods can be averaged to obtain a percentage described herein. It is further to be understood that the degree of polymerization or cross-linking described herein is different than “degree of polymerization” defined as the number of repeating units in a polymer molecule.

It is also possible to form a 3D article (e.g., a mold) from a build material described herein using a vat polymerization method, such as an SLA or DLP method. Thus, in some cases, a method of forming a 3D article described herein comprises retaining a build material described herein in a fluid state in a container and selectively applying energy (particularly, for instance, the curing radiation having the peak wavelength λ) to the build material in the container to solidify at least a portion of a fluid layer of the build material, thereby forming a solidified layer that defines a cross-section of the 3D article. Additionally, a method described herein can further comprise raising or lowering the solidified layer of build material to provide a new or second fluid layer of unsolidified build material at the surface of the fluid build material in the container, followed by again selectively applying energy (e.g., the curing radiation) to the build material in the container to solidify at least a portion of the new or second fluid layer of the build material to form a second solidified layer that defines a second cross-section of the 3D article. Further, the first and second cross-sections of the 3D article can be bonded or adhered to one another in the z-direction (or build direction corresponding to the direction of raising or lowering recited above) by the application of the energy for solidifying the build material. Moreover, in some instances, the electromagnetic radiation has an average wavelength of 300-900 nm, and in other embodiments the electromagnetic radiation has an average wavelength that is less than 300 nm. In some cases, the curing radiation is provided by a computer controlled laser beam or other light source, such as a DLP light source. In addition, in some cases, raising or lowering a solidified layer of build material is carried out using an elevator platform disposed in the container of fluid build material. A method described herein can also comprise planarizing a new layer of fluid build material provided by raising or lowering an elevator platform. Such planarization can be carried out, in some cases, by a wiper or roller.

It is further to be understood that the foregoing process can be repeated a desired number of times to provide the 3D article (e.g., the mold). For example, in some cases, this process can be repeated “n” number of times, wherein n can be up to about 100,000, up to about 50,000, up to about 10,000, up to about 5000, up to about 1000, or up to about 500. Thus, in some embodiments, a method of forming a 3D article described herein can comprise selectively applying energy (e.g., curing radiation of peak wavelength λ) to a build material in a container to solidify at least a portion of an nth fluid layer of the build material, thereby forming an nth solidified layer that defines an nth cross-section of the 3D article, raising or lowering the nth solidified layer of build material to provide an (n+1)th layer of unsolidified build material at the surface of the fluid build material in the container, selectively applying energy to the (n+1)th layer of build material in the container to solidify at least a portion of the (n+1)th layer of the build material to form an (n+1)th solidified layer that defines an (n+1)th cross-section of the 3D article, raising or lowering the (n+1)th solidified layer of build material to provide an (n+2)th layer of unsolidified build material at the surface of the fluid build material in the container, and continuing to repeat the foregoing steps to form the 3D article. Further, it is to be understood that one or more steps of a method described herein, such as a step of selectively applying energy (e.g., curing radiation described herein) to a layer of build material, can be carried out according to an image of the 3D article in a computer-readable format or digital format. General methods of 3D printing using stereolithography are further described, inter alia, in U.S. Pat. Nos. 5,904,889 and 6,558,606.

In a vat polymerization method such as described above, the build material may be partially cured as described above. For example, in some embodiments, selectively applying energy to the build material in the container to solidify at least a portion of a fluid layer of the build material may include partially curing at least a portion of a fluid layer of the build material. In other embodiments, partial curing of at least a portion of a fluid layer of the build material may occur after a first layer of the build material is provided and solidified, before or after a second layer of the build material is provided or solidified, or before or after one, several, or all subsequent layers of the build material are provided or solidified.

Additionally, in some embodiments of a vat polymerization method described herein, after partial curing or after the desired 3D article (e.g., mold) is formed, post-curing as described above may be performed. The desired 3D article may be, for example, an article that corresponds to the design in a CAD file or other digital file, image, or model corresponding to the desired 3D article.

Turning now to other aspects of a mold (e.g., first mold) described herein, the first mold may have any shape not inconsistent with the technical objectives of the present disclosure. In some implementations, the interior volume of the first mold may define a vascular network or topology. Moreover, in some embodiments, more than one vascular network or vascular topology may be incorporated into a first mold.

For reference purposes herein, a vascular network or topology comprises the 3D features relating to or comprising a vessel or one or more networks of vessels, which can be configured to facilitate or transport media (e.g., vasculature of a biological system). In some cases, media may comprise but are not limited to blood, bile, urine, air, or oxygen. Moreover, as understood by a person of ordinary skill in the art, the term “vasculature” refers to a perfusable 2D or 3D interconnected tubular transport system. More particularly, a “vasculature” or “vascular structure” can convey biological fluids, nutrients, drugs, biologics, and/or gases or other substances to a cell, cellular aggregate, or tissue, including to maintain viability of the cell/tissue. “Vasculature” or a “vasculature structure” may also convey waste away from a cell, cellular aggregate, or tissue. In some cases, “vasculature” or a “vascular structure” described herein interpenetrates or is embedded within another network or within a tissue or a tissue mimic or substitute or extracellular matrix. Further, in some embodiments, the “vasculature” or “vascular structure” of a system, or method described herein does not consist of or comprise regular cylinders or other regular geometric shapes (e.g., such regular geometric shapes joined together to form a network), but instead has an irregular geometric structure, shape, or cross-section. Additionally, in some cases, the “vasculature” or “vascular structure” of a system or method described herein has a perfusable architecture or structure mimicking a mammalian (e.g., human) vascular system that includes an artery, arteriole, capillary bed, venule, vein, or a combination of two or more of the foregoing.

A first mold described herein can have any interior volume not inconsistent with the objectives of the present disclosure. For example, in some preferred embodiments, the first mold has a total interior volume of 0.01-10 liter (L), 0.01-5 L, 0.01-1 L, 0.01-0.5 L, 0.01-0.25 L, 0.01-0.1 L, 0.01-0.05 L, 0.05-10 L, 0.05-1 L, 0.05-0.5 L, 0.05-0.25 L, 0.05-0.1 L, 0.1-10 L, 0.1-5 L, 0.1-1 L, 0.1-0.5 L, 0.25-10 L, 0.25-5 L, 0.25-1 L, 0.5-10 L, 0.5-5 L, 0.5-5 L, 0.5-1 L, 1-10 L, or 1-5 L. Moreover, the first mold and its interior volume can have any shape not inconsistent with the objectives of the present disclosure. In some instances, the interior volume has a shape corresponding to the exterior surface of the final molded article to be formed by a method described herein.

In some preferred embodiments, the interior volume of a first mold described herein defines vasculature or a vascular network or has a vascular topology. In some such cases, the interior volume of the mold can be defined by tubular features having a small average size or diameter, such as corresponding to a biological system. For example, in some implementations, a first mold described herein has an interior volume having a vascular topology formed from one or more tubular structures, and the tubular structures have an average diameter of less than 30 mm, less than 20 mm, less than 15 mm, less than 10 mm, less than 5 mm, or less than 1 mm. In some instances, for example, the tubular structures have an average diameter of 1-30 mm, 1-25 mm, 1-20 mm, 1-15 mm, 1-10 mm, or 1-5 mm. In other cases, the tubular structures have an average diameter of less than 1 mm, such as an average diameter of 5-900 microns (μm), 5-700 μm, 5-500 μm, 5-300 μm, 5-100 μm, 5-50 μm, 10-500 μm, 10-300 μm, 10-100 μm, 10-50 μm, 50-500 μm, 50-300 μm, or 50-100 μm. Systems, methods, and materials described herein, in some cases, can make it possible to form such delicate and complex 3D articles (e.g., vascular networks) from a variety of materials, including in a facile and/or reliable manner not easily achieved otherwise, as further described herein.

Turning now to other aspects of methods described herein, methods described herein comprise injecting a first fluid material into a first mold, such as may occur through one or more injection ports of a system described herein. The first fluid material may be any material not inconsistent with the technical objectives of the present disclosure. In some cases, a first fluid material comprises, consists of, consists essentially of, or is a biomolecule or biopolymer (or a solution or dispersion thereof), an organic polymer (or a solution or dispersion thereof), a thermoplastic (which may also be an organic polymer), a wax, a metal, or a combination of two or more of the foregoing.

In some embodiments, a biomolecule or a biopolymer used in a first fluid material comprises decellularized extracellular matrix (ECM) of a tissue or organ, a protein or a functionalized protein, a polysaccharide or a functionalized polysaccharide such as a glycosaminoglycan or a functionalized glycosaminoglycan, or a combination of two or more of the foregoing. For reference purposes herein, decellularized extracellular matrix (ECM) comprises the extracellular matrix of a tissue or organ wherein the cellular material, particularly the DNA of the cellular material of the tissue or organ, has been removed and the extracellular material (e.g., proteins, glycoproteins, and polysaccharides) remains.

In some implementations, as noted above, a biomolecule or a biopolymer used in a first fluid material comprises, consists of, consists essentially of, or is a protein or a functionalized protein. In some such embodiments, the protein or functionalized protein comprises silk (e.g., silk fibroin), silk (meth)acrylate (that is, (meth)acrylated silk, as understood by a person of ordinary skill in the art), silk (meth)acrylamide (that is, (meth)acrylamide-functionalized silk, as appreciated by a person of ordinary skill in the art), thiolated silk, collagen, collagen methacrylate, collagen methacrylamide, gelatin, gelatin methacrylate, gelatin methacrylamide, thiolated gelatin, elastin methacrylate, elastin methacrylamide, fibrin, synthetic peptides, or a combination of two or more of the foregoing.

Moreover, as noted above, in some cases, a biomolecule or a biopolymer used in a first fluid material described herein comprises, consists of, consists essentially of, or is a polysaccharide or a functionalized polysaccharide. In some such implementations, for example, the polysaccharide or functionalized polysaccharide comprises alginate, cellulose, cellulose acrylate, cellulose methacrylamide, chitosan, chitosan methacrylate, chitosan methacrylamide, thiolated chitosan, dextran, dextran methacrylate, dextran methacrylamide, chondroitin sulfate methacrylate, chondroitin sulfate methacrylamide, heparin methacrylate, heparin methacrylamide, or a combination of two or more of the foregoing.

Further, as noted above, in some embodiments, a biomolecule or a biopolymer used in a first fluid material comprises, consists of, consists essentially of, or is a glycosaminoglycan or a functionalized glycosaminoglycan. In some such cases, the glycosaminoglycan or functionalized glycosaminoglycan comprises hyaluronic acid, hyaluronic acid methacrylate, hyaluronic acid methacrylamide, thiolated hyaluronic acid, or a combination of two or more of the foregoing.

Additionally, in some implementations, an organic polymer used in a first fluid material comprises a PEG-based polymer, poly (N-isopropyl acrylamide), poloxamer diacrylate, or poloxamer methacrylamide, or a solution or dispersion of one or more of the foregoing. Non-limiting examples of a PEG-based polymer include polyethylene glycol norbornene, polyethylene glycol dithiol, PEG-based peptide conjugates, or combinations thereof.

In still other embodiments, as noted above, the first fluid material comprises, consists of, consists essentially of, or is a thermoplastic. In some such cases, the thermoplastic comprises polyurethane, polycaprolactone (PCL), or a combination thereof. In some implementations, the thermoplastic comprises an elastomer. Other thermoplastic materials may also be used.

Moreover, as noted above, in some cases a first fluid material described herein comprises, consists of, consists essentially of, or is a wax. The wax can be any wax not inconsistent with the technical objectives of the present disclosure, including any wax described hereinabove in the context of waxes which may be used to form a first mold described herein. For example, in some embodiments, the wax can be a lipophilic and/or malleable solid near ambient temperature. In some implementations, the wax can include an alkane, such as an alkane with a melting point above about 40° C. In some other cases, the wax may be insoluble in water but soluble in organic and/or nonpolar solvents.

In some embodiments when a wax is used as the first fluid material, the wax can be prepared by transferring it into a container, heating the wax, and then using it in the injection process. In some cases, the wax can be processed at room temperature. In some embodiments, the temperature of the wax in the injection process is between about 4° C. and 40° C. or between about 20° C. and 40° C. In some implementations, a mixture or combination of waxes can be used to obtain desired physical, mechanical, and/or chemical properties.

Further, as noted above, in still other embodiments the first fluid material comprises, consists of, consists essentially of, or is a metal or a combination, mixture, or alloy of two or more metals. In some cases, the metal a supercooled liquid metal. In some instances, the metal comprises gallium, indium, Field's metal or alloy (a eutectic alloy of bismuth, indium and tin), gallium-indium, gallium-tin, and gallium-indium-tin, or any combination thereof. Other metals may also be used, and the specific metal or combination, mixture, or alloy of metals is not particularly limited.

Turning to more detail about certain steps of methods described herein, in some embodiments, a method described herein comprises pressurizing the chamber. The chamber may be pressurized to any pressure not inconsistent with the technical objectives of the present disclosure. In some cases, pressurizing the chamber comprises pressurizing the chamber to a pressure greater than 1 atm. However, in some cases, pressurizing the chamber comprises pressurizing the chamber to a pressure less than 1 atm. Many chamber pressures may be contemplated. In some preferred embodiments, pressurizing the chamber comprises pressurizing the chamber to a pressure between 0.5 atm and 1 atm or between 0.5 atm and 10 atm. In some cases, the chamber is pressurized to a pressure between 0.5 atm and 50 atm, between 0.5 atm and 100 atm, between 0.5 atm and 200 atm, between 0.5 atm and 300 atm, between 0.5 atm and 400 atm, between 0.5 atm and 500 atm, between 0.5 atm and 600 atm, between 0.5 atm and 700 atm, between 0.5 atm and 800 atm, between 0.5 atm and 900 atm, between 0.5 atm and 1000 atm, between 0.5 atm and 1100 atm, between 0.5 atm and 1200 atm, between 0.5 atm and 1300 atm, between 0.5 atm and 1400 atm, or between 0.5 atm and 1500 atm. Additionally, in some additional preferred implementations, pressurizing the chamber comprises pressurizing the chamber to a pressure between 1 atm and 10 atm or between 1 atm and 50 atm. In other cases, the chamber is pressurized to a pressure between 1 atm and 100 atm, between 1 atm and 200 atm, between 1 atm and 300 atm, between 1 atm and 400 atm, between 1 atm and 500 atm, between 1 atm and 600 atm, between 1 atm and 700 atm, between 1 atm and 800 atm, between 1 atm and 900 atm, between 1 atm and 1000 atm, between 1 atm and 1100 atm, between 1 atm and 1200 atm, between 1 atm and 1300 atm, between 1 atm and 1400 atm, or between 1 atm and 1500 atm. Further, in some cases, pressurizing the chamber comprises pressurizing the chamber to a pressure between 10 atm and 50 atm, between 10 atm and 100 atm, between 10 atm and 200 atm, between 10 atm and 300 atm, between 10 atm and 400 atm, between 10 atm and 500 atm, between 10 atm and 600 atm, between 10 atm and 700 atm, between 10 atm and 800 atm, between 10 atm and 900 atm, between 10 atm and 1000 atm, between 10 atm and 1100 atm, between 10 atm and 1200 atm, between 10 atm and 1300 atm, between 10 atm and 1400 atm, or between 10 atm and 1500 atm. In some implementations, pressurizing the chamber comprises pressurizing the chamber to a pressure between 50 atm and 100 atm, between 50 atm and 200 atm, between 50 atm and 300 atm, between 50 atm and 400 atm, between 50 atm and 500 atm, between 50 atm and 600 atm, between 50 atm and 700 atm, between 50 atm and 800 atm, between 50 atm and 900 atm, between 50 atm and 1000 atm, between 50 atm and 1100 atm, between 50 atm and 1200 atm, between 50 atm and 1300 atm, between 50 atm and 1400 atm, or between 50 atm and 1500 atm. Moreover, in some implementations, pressurizing the chamber comprises pressurizing the chamber to a pressure between 100 atm and 200 atm, between 100 atm and 300 atm, between 100 atm and 400 atm, between 100 atm and 500 atm, between 100 atm and 600 atm, between 100 atm and 700 atm, between 100 atm and 800 atm, between 100 atm and 900 atm, between 100 atm and 1000 atm, between 100 atm and 1100 atm, between 100 atm and 1200 atm, between 100 atm and 1300 atm, between 100 atm and 1400 atm, or between 100 atm and 1500 atm. Further, in some embodiments, pressurizing the chamber comprises pressurizing the chamber to a pressure between 200 atm and 300 atm, between 200 atm and 400 atm, between 200 atm and 500 atm, between 200 atm and 600 atm, between 200 atm and 700 atm, between 200 atm and 800 atm, between 200 atm and 900 atm, between 200 atm and 1000 atm, between 200 atm and 1100 atm, between 200 atm and 1200 atm, between 200 atm and 1300 atm, between 200 atm and 1400 atm, or between 200 atm and 1500 atm. Additionally, in some cases, pressurizing the chamber comprises pressurizing the chamber to a pressure between 300 atm and 400 atm, between 300 atm and 500 atm, between 300 atm and 600 atm, between 300 atm and 700 atm, between 300 atm and 800 atm, between 300 atm and 900 atm, between 300 atm and 1000 atm, between 300 atm and 1100 atm, between 300 atm and 1200 atm, between 300 atm and 1300 atm, between 300 atm and 1400 atm, or between 300 atm and 1500 atm. Moreover, in some implementations, pressurizing the chamber comprises pressurizing the chamber to a pressure between 400 atm and 500 atm, between 400 atm and 600 atm, between 400 atm and 700 atm, between 400 atm and 800 atm, between 400 atm and 900 atm, between 400 atm and 1000 atm, between 400 atm and 1100 atm, between 400 atm and 1200 atm, between 400 atm and 1300 atm, between 400 atm and 1400 atm, or between 400 atm and 1500 atm. Also, in some embodiments, pressurizing the chamber comprises pressurizing the chamber to a pressure between 500 atm and 600 atm, between 500 atm and 700 atm, between 500 atm and 800 atm, between 500 atm and 900 atm, between 500 atm and 1000 atm, between 500 atm and 1100 atm, between 500 atm and 1200 atm, between 500 atm and 1300 atm, between 500 atm and 1400 atm, or between 500 atm and 1500 atm. Moreover, in some cases, pressurizing the chamber comprises pressurizing the chamber to a pressure between 600 atm and 700 atm, between 600 atm and 800 atm, between 600 atm and 900 atm, between 600 atm and 1000 atm, between 600 atm and 1100 atm, between 600 atm and 1200 atm, between 600 atm and 1300 atm, between 600 atm and 1400 atm, or between 600 atm and 1500 atm. Further, in some cases, pressurizing the chamber comprises pressurizing the chamber to a pressure between 800 atm and 900 atm, between 800 atm and 1000 atm, between 800 atm and 1100 atm, between 800 atm and 1200 atm, between 800 atm and 1300 atm, between 800 atm and 1400 atm, between 800 atm and 1500 atm, between 900 atm and 1000 atm, between 900 atm and 1100 atm, between 900 atm and 1200 atm, between 900 atm and 1300 atm, between 900 atm and 1400 atm, or between 900 atm and 1500 atm. Also, in some embodiments, pressurizing the chamber comprises pressurizing the chamber to a pressure between 1000 atm and 1100 atm, between 1000 atm and 1200 atm, between 1000 atm and 1300 atm, between 1000 atm and 1400 atm, between 1000 atm and 1500 atm, between 1100 atm and 1200 atm, between 1100 atm and 1300 atm, between 1100 atm and 1400 atm, between 1100 atm and 1500 atm, between 1200 atm and 1300 atm, between 1200 atm and 1400 atm, between 1200 atm and 1500 atm, between 1300 atm and 1400 atm, or between 1400 atm and 1500 atm.

Moreover, in some cases, pressurizing the chamber comprises pressurizing the chamber to a pressure greater than an injection pressure of the first fluid material into the interior volume of the first mold. For reference purposes herein, an injection pressure may comprise the pressure of the first fluid material entering the interior volume, such as may occur through the one or more injection ports through the one or more receiving ports. Many injection pressures may be contemplated. Any injection pressure that is not inconsistent with the objectives of the present disclosure may be used. In some preferred embodiments, the injection pressure of the first fluid material into the interior volume of the first mold comprises a pressure between 0.3 atm and 0.5 atm, between 0.3 atm and 1 atm, or between 0.3 atm and 10 atm. In some instances, the injection pressure is between 0.3 atm and 50 atm, between 0.3 atm and 100 atm, between 0.3 atm and 200 atm, between 0.3 atm and 300 atm, between 0.3 atm and 400 atm, between 0.3 atm and 500 atm, between 0.3 atm and 600 atm, between 0.3 atm and 700 atm, between 0.3 atm and 800 atm, between 0.3 atm and 900 atm, between 0.3 atm and 1000 atm, between 0.3 atm and 1100 atm, between 0.3 atm and 1200 atm, between 0.3 atm and 1300 atm, between 0.3 atm and 1400 atm, or between 0.3 atm and 1500 atm. In some cases, the injection pressure of the first fluid material into the interior volume of the first mold comprises a pressure between 0.5 atm and 1 atm, between 0.5 atm and 10 atm, between 0.5 atm and 50 atm, between 0.5 atm and 100 atm, between 0.5 atm and 200 atm, between 0.5 atm and 300 atm, between 0.5 atm and 400 atm, between 0.5 atm and 500 atm, between 0.5 atm and 600 atm, between 0.5 atm and 700 atm, between 0.5 atm and 800 atm, between 0.5 atm and 900 atm, between 0.5 atm and 1000 atm, between 0.5 atm and 1100 atm, between 0.5 atm and 1200 atm, between 0.5 atm and 1300 atm, between 0.5 atm and 1400 atm, or between 0.5 atm and 1500 atm. Additionally, in some implementations, the injection pressure of the first fluid material into the interior volume of the first mold comprises a pressure between 1 atm and 10 atm, between 1 atm and 50 atm, between 1 atm and 100 atm, between 1 atm and 200 atm, between 1 atm and 300 atm, between 1 atm and 400 atm, between 1 atm and 500 atm, between 1 atm and 600 atm, between 1 atm and 700 atm, between 1 atm and 800 atm, between 1 atm and 900 atm, between 1 atm and 1000 atm, between 1 atm and 1100 atm, between 1 atm and 1200 atm, between 1 atm and 1300 atm, between 1 atm and 1400 atm, or between 1 atm and 1500 atm. Further, in some cases, the injection pressure of the first fluid material into the interior volume of the first mold comprises a pressure between 10 atm and 50 atm, between 10 atm and 100 atm, between 10 atm and 200 atm, between 10 atm and 300 atm, between 10 atm and 400 atm, between 10 atm and 500 atm, between 10 atm and 600 atm, between 10 atm and 700 atm, between 10 atm and 800 atm, between 10 atm and 900 atm, between 10 atm and 1000 atm, between 10 atm and 1100 atm, between 10 atm and 1200 atm, between 10 atm and 1300 atm, between 10 atm and 1400 atm, or between 10 atm and 1500 atm. In some embodiments, the injection pressure of the first fluid material into the interior volume of the first mold comprises a pressure between 50 atm and 100 atm, between 50 atm and 200 atm, between 50 atm and 300 atm, between 50 atm and 400 atm, between 50 atm and 500 atm, between 50 atm and 600 atm, between 50 atm and 700 atm, between 50 atm and 800 atm, between 50 atm and 900 atm, between 50 atm and 1000 atm, between 50 atm and 1100 atm, between 50 atm and 1200 atm, between 50 atm and 1300 atm, between 50 atm and 1400 atm, or between 50 atm and 1500 atm. Moreover, in some implementations, the injection pressure of the first fluid material into the interior volume of the first mold comprises a pressure between 100 atm and 200 atm, between 100 atm and 300 atm, between 100 atm and 400 atm, between 100 atm and 500 atm, between 100 atm and 600 atm, between 100 atm and 700 atm, between 100 atm and 800 atm, between 100 atm and 900 atm, between 100 atm and 1000 atm, between 100 atm and 1100 atm, between 100 atm and 1200 atm, between 100 atm and 1300 atm, between 100 atm and 1400 atm, or between 100 atm and 1500 atm. Further, in some embodiments, the injection pressure of the first fluid material into the interior volume of the first mold comprises a pressure between 200 atm and 300 atm, between 200 atm and 400 atm, between 200 atm and 500 atm, between 200 atm and 600 atm, between 200 atm and 700 atm, between 200 atm and 800 atm, between 200 atm and 900 atm, between 200 atm and 1000 atm, between 200 atm and 1100 atm, between 200 atm and 1200 atm, between 200 atm and 1300 atm, between 200 atm and 1400 atm, or between 200 atm and 1500 atm. Additionally, in some cases, the injection pressure of the first fluid material into the interior volume of the first mold comprises a pressure between 300 atm and 400 atm, between 300 atm and 500 atm, between 300 atm and 600 atm, between 300 atm and 700 atm, between 300 atm and 800 atm, between 300 atm and 900 atm, between 300 atm and 1000 atm, between 300 atm and 1100 atm, between 300 atm and 1200 atm, between 300 atm and 1300 atm, between 300 atm and 1400 atm, or between 300 atm and 1500 atm. Moreover, in some implementations, the injection pressure of the first fluid material into the interior volume of the first mold comprises a pressure between 400 atm and 500 atm, between 400 atm and 600 atm, between 400 atm and 700 atm, between 400 atm and 800 atm, between 400 atm and 900 atm, between 400 atm and 1000 atm, between 400 atm and 1100 atm, between 400 atm and 1200 atm, between 400 atm and 1300 atm, between 400 atm and 1400 atm, or between 400 atm and 1500 atm. Further, in some embodiments, the injection pressure of the first fluid material into the interior volume of the first mold comprises a pressure between 500 atm and 600 atm, between 500 atm and 700 atm, between 500 atm and 800 atm, between 500 atm and 900 atm, between 500 atm and 1000 atm, between 500 atm and 1100 atm, between 500 atm and 1200 atm, between 500 atm and 1300 atm, between 500 atm and 1400 atm, or between 500 atm and 1500 atm. Moreover, in some cases, the injection pressure of the first fluid material into the interior volume of the first mold comprises a pressure between 600 atm and 700 atm, between 600 atm and 800 atm, between 600 atm and 900 atm, between 600 atm and 1000 atm, between 600 atm and 1100 atm, between 600 atm and 1200 atm, between 600 atm and 1300 atm, between 600 atm and 1400 atm, or between 600 atm and 1500 atm. Further, in some cases, the injection pressure of the first fluid material into the interior volume of the first mold comprises a pressure between 800 atm and 900 atm, between 800 atm and 1000 atm, between 800 atm and 1100 atm, between 800 atm and 1200 atm, between 800 atm and 1300 atm, between 800 atm and 1400 atm, between 800 atm and 1500 atm, between 900 atm and 1000 atm, between 900 atm and 1100 atm, between 900 atm and 1200 atm, between 900 atm and 1300 atm, between 900 atm and 1400 atm, or between 900 atm and 1500 atm. Also, in some embodiments, the injection pressure of the first fluid material into the interior volume of the first mold comprises a pressure between 1000 atm and 1100 atm, between 1000 atm and 1200 atm, between 1000 atm and 1300 atm, between 1000 atm and 1400 atm, between 1000 atm and 1500 atm, between 1100 atm and 1200 atm, between 1100 atm and 1300 atm, between 1100 atm and 1400 atm, between 1100 atm and 1500 atm, between 1200 atm and 1300 atm, between 1200 atm and 1400 atm, between 1200 atm and 1500 atm, between 1300 atm and 1400 atm, or between 1400 atm and 1500 atm.

Additionally, in some preferred embodiments, pressurizing the chamber comprises pressurizing the chamber to a pressure less than a crack pressure threshold of the first mold. For reference purposes herein, the crack pressure threshold of the first mold comprises the pressure at which the first mold cracks, bursts, or breaks during injection of the first fluid material. In some instances, the crack pressure threshold may be determined by the material of the first mold. For example, in some cases, the crack pressure threshold of the first mold may be dependent on the mechanical properties and/or mechanical strength (e.g., tensile strength, elongation at break) of the material of the first mold. Many crack pressure thresholds may be contemplated. In some implementations, the crack pressure threshold comprises a pressure between 5 atm and 100 atm, between 5 atm and 500 atm, between 5 atm and 1500 atm, between 100 atm and 500 atm, between 100 atm and 1500 atm, or between 500 atm and 1500 atm.

Additionally, in some implementations, a method described herein comprises solidifying the injected fluid material within the interior volume of the first mold to form a solidified object. In some cases, solidifying the injected fluid material within the interior volume of the first mold to form the solidified object comprises cooling the first fluid material within the interior volume of the first mold to form the solidified object. In some such cases, cooling the first fluid material within the interior volume of the first mold to form the solidified object may comprise cooling the entire chamber or other environment of the first mold, including to a temperature that is equal to or lower than freezing point of the fluid material. Such cooling can be passive (e.g., simply allowing time to pass, such that the fluid material reaches thermal equilibrium with its surroundings) or active (e.g., accelerating the reduction in temperature, rather than simply allowing time to pass, such as by directing relatively cool air or other fluid over or onto the fluid material or over or onto the surroundings of the fluid material). In some implementations, cooling the first fluid material within the interior volume of the first mold to form the solidified object comprises cooling the first fluid material within the interior volume at a temperature between −90° C. and −40° C., between −40° C. and 0° C., between 0° C. and 4° C., between 4° C. and 20° C., between 20° C. and 40° C., or between 40° C. and 65° C. for 10 minutes-20 minutes, 20 minutes-1 hour, 1 hour-2 hours, 2 hours-6 hours, 6 hours-12 hours, 0.5-1 day, 1-5 days, or 1-3 days.

In some cases, a method described herein comprises removing the first mold from the solidified object. The first mold can be removed in any manner not inconsistent with the technical objectives of the present disclosure. In some embodiments, removing the first mold comprises dissolving, dispersing, melting, and/or degrading the mold. For reference purposes herein, dissolving or dispersing the first mold comprises applying water, an aqueous solution, or organic solvent to solubilize or disperse the mold. Moreover, for reference purposes herein, degrading the first mold comprises breaking down one or more chemical bonds present in the mold, such that the material forming the mold degrades chemically and forms new chemical species.

In some implementations, removing the first mold comprises dissolving or dispersing the mold in water or an aqueous solution. Multiple washes of the mold with water or an aqueous solution may be used. Moreover, it is to be understood that an “aqueous solution” is a solution in which at least 50% of the solvent is water. In some embodiments, the aqueous solution comprises a glycol. In some cases, a glycol may include glycerol or polyethylene glycol. Other glycols may also be used. In some implementations, a glycol may be used in the aqueous solution in an amount of 10-40 wt. %, such as in an amount of 10 wt. %, 20 wt. %, 30 wt. %, or 40 wt. %, based on the total weight of the aqueous solution. In some cases, the aqueous solution comprises a chelating agent. In some implementations, the chelating agent can be sodium citrate or ethylenediaminetetraacetic acid (EDTA).

Additionally, it is to be understood that the water (or aqueous solution), in some cases, can have a basic pH or an acidic pH. For instance, in some cases, the water or aqueous solution used to remove the mold has a pH of about 5 to about 7. In some embodiments, the water or aqueous solution used to remove the mold has a pH of about 7 to 14, 7 to 13, 7 to 12, 7 to 10, 8 to 14, 8 to 13, 8 to 12, or 8 to 10. As understood by one of ordinary skill in the art, such a pH can be obtained, for example, by the inclusion of a Bronsted-Lowry acid or base. For instance, in some cases, a strong acid or a strong base, such as hydrochloric acid or sodium hydroxide, respectively, may be included in the water (or an aqueous solution) used to remove the mold at a desired concentration to provide a desired pH, as understood by a person of ordinary skill in the art. For example, in some implementations, an aqueous solution of 3 M NaOH or a 6 M NaOH may be used. Moreover, other proton or hydroxide sources may also be used.

Moreover, in some embodiments, removing the first mold according to a method described herein comprises immersing the first mold (and the solidified object contained therein) in water or aqueous solution (e.g., while in the chamber or in a container). Further, in some cases, the mold (and the article within) is immersed for a specific time period at a specific temperature. For example, in some embodiments, the first mold is immersed for 10 minutes-20 minutes, 20 minutes-1 hour, 1 hour-2 hours, 2 hours-6 hours, 6-12 hours, 0.5-1 day, 1-5 days, or 1-3 days at a temperature of −25° C.-0° C., 0° C.-4° C., 4° C.-25° C., 25° C.-50° C., 25° C.-45° C., 25° C.-40° C., 30° C.-50° C., 30° C.-45° C., or 35° C.-40° C.

Further, in some cases, agitation is used in addition to exposing the mold to water or an aqueous solution. Such agitation may be provided, in some instances, by mechanical shaking or stirring or by sonication.

Additionally, in some implementations, removing the first mold from the solidified object according to a method described herein may also comprise removing the first mold with enzymatic dissolution, degradation, and/or digestion. That is, the first mold is dissolved, degraded, and/or digested with a protease and/or peptidase, including trypsin, collagenase, proteinase K, cathepsin K, or any combination thereof.

In some embodiments, other processes may be used to remove the first mold from the solidified object. In some cases, the first mold may be removed by a mechanical process. For reference purposes herein, a mechanical process may comprise the physical removal of the mold wherein the mold is peeled or torn away from the solidified object. Moreover, in some implementations, the first mold may be removed by swelling the mold or drying the mold.

Additionally, two or more of the foregoing processes or techniques to remove the first mold from the solidified object may be used in combination. For example, in some embodiments, enzymatic dissolution may be used to partially dissolve and/or degrade the mold, and a subsequent immersion of the mold in 3 M NaOH may be used to remove the remaining portion of the mold.

As previously mentioned, in some embodiments, the solidified object is the final 3D article formed by a method described herein. In some instances, the solidified object comprises an artificial tissue, an artificial organ, a tissue model, a phantom, a stent, or a vascular cast. However, in some cases, this solidified object may be modified. For example, in some implementations, a method described herein further comprises modifying an exterior surface of the solidified object. In some embodiments, modifying an exterior surface of the solidified object comprises roughening or smoothing the surface of the solidified object, coating the exterior surface of the solidified object, or any combination thereof. In some cases, coating the exterior surface of the solidified object comprises dipcoating the solidified object, electroplating the solidified object, or a combination thereof. In some implementations, modifying the exterior surface of the solidified object comprises selectively coating a portion of the surface.

In some cases, modifying the exterior surface of the solidified object comprises roughening or smoothing the surface of the solidified object. In some implementations, the surface roughness (Ra) of the solidified object after modifying the surface of the solidified object is less than 10 μm, 5 μm, 3 μm, 2 μm, 1 μm, 0.8 μm, 0.6 μm, 0.5 μm, 0.4 μm, 0.3 μm, 0.2 μm, or 0.1 μm. In some embodiments, the surface roughness of the solidified object may have different surface roughness values on different parts of the solidified object.

In some embodiments, modifying the exterior surface of the solidified object comprises coating the exterior surface of the solidified object. In some embodiments, coating the exterior surface of the solidified object comprises coating the exterior surface with a layer of cells, a cell-adhesive material, collagen, gelatin, fibronectin, laminin, poly-lysine, PEG-based peptide conjugates, polyurethane, or any combination thereof.

In some cases, coating the exterior surface of the solidified object comprises coating the surface with a layer of metal. In some cases, the metal comprises copper, nickel, or gold. In some embodiments, the metal comprises a combination, mixture, or alloy of two or more metals. In some implementations, coating the exterior surface of the solidified object may comprise coating the surface with a lipid. In some embodiments, the lipid comprises a phospholipid, steroid, glycolipid, sphingolipid, amphiphile, or any combination thereof. In some cases, the phospholipid comprises a zwitterionic phospholipid, or anionic phospholipid, or PEGylated phospholipid or any combination thereof. In some embodiments, the lipid comprises polylactic acid or a triglyceride. In some implementations, coating the exterior surface of the solidified object comprises coating the exterior surface of the solidified object with a coating material that comprises hydrophobic regions. In some cases, the coating material comprises serum. In some embodiments, the hydrophobic containing material comprises a peptide or protein. In some implementations, the hydrophobic containing material comprises a lipid. In some embodiments, coating the exterior surface of the solidified object allows for cell adhesion.

Many techniques for applying a coating to the exterior surface of the solidified object may be contemplated. Any technique or combination of techniques for applying a coating to the exterior surface of the solidified object not inconsistent with the technical objectives of the present disclosure may be used. In some instances, modifying the exterior surface of the solidified object comprises dip coating the solidified object. In some embodiments, dip coating can be performed in solution, wherein the solution is then dried and solidified. In some implementations, dip coating can be performed in solution, wherein the solution is then crystallized. In some instances, dip coating can be performed using nanometer-thick polyelectrolyte polymer films layer by layer. In some embodiments, dip coating can be performed in suspension of magnetic particles. In some cases, the magnetic field can align or control the surface changes. In some implementations, the solidified object (e.g., in the form of independent vascular networks) are electrically charged and coated by powder casting or coating. In some instances, the process includes laminin first, then followed by dip coating in collagen. In some embodiments, the process does not include a hard bake, such as required in those processes used in powder coating of parts for automobiles. In some embodiments, the solidified object can be coated using an organic polymer in alternating layers (OPAL) process, where each coating layer can include a different material, which may give rise to a different color, along one or more directions on the surface and/or along the growth direction of the solidified object, which may form a series of colors (e.g., rainbow) across the surface. In other words, the solidified object can be coated to have a gradient in the coating by controlled mixing in the solidified object in both 2D and/or 3D arrangements of the coating, along a surface and/or through the layer of the coating.

Moreover, in some embodiments, modifying the exterior surface of the solidified object comprises electroplating the solidified object. In some implementations, electroplating may be directionally applied. In some cases, the electroplating is applied more at distal than proximal on the surface of the solidified object. Further, in some implementations, the electroplating is uniformly applied evenly over the surface. Additionally, in some embodiments, the solidified object comprises a metal, and the electroplating may be applying an additional layer of the same metal. However, in some cases, the solidified object comprises a metal, and the electroplating may also be applying a layer of a different metal.

As previously discussed, in some cases, the solidified object is not the final three-dimensional article formed by a method described herein. Instead, in some such instances, the solidified object is itself used as a mold. In some embodiments, this mold comprises a positive mold. Thus, in some implementations, a method described herein further comprises applying a second fluid material to the exterior surface of the solidified object, and solidifying the second fluid material (or a portion thereof) on the surface of the solidified object to form a second mold of the solidified object. Moreover, in some such implementations, the method further comprises removing the solidified object from the second fluid material (e.g., after the second fluid material has solidified as described above) to provide a second mold of the solidified object comprising an interior volume. In such cases, the solidified object can be removed in any manner not inconsistent with the technical objectives of the present disclosure, such as by melting, dissolving, dispersing, or degrading the solidified object in a manner described above for removing the first mold. Other methods for removing the solidified object may also be used, and the specific technique is not necessarily limited.

Moreover, in some embodiments, the second mold may be the final three-dimensional article formed by a method described herein. In some such cases, the second mold may be used for further molding processes.

The second fluid material used in a method described herein can be any material not inconsistent with the technical objectives of the present disclosure. In some embodiments, the second fluid material comprises, consists of, consists essentially of, or is any material described above for a first mold. Thus, the second fluid material may comprise, consist of, consist essentially of, or is a hydrogel, a wax, a plastic, polyvinyl alcohol, PEG-norbornene, MMP-sensitive PEGs, gelatin methacrylate, or any combination thereof. Moreover, in some cases, the second fluid material may comprise, consist of, consist essentially of, or is any material described for the first fluid material. Thus, in some cases, a second fluid material may comprise, consist of, consist essentially of, or is a biomolecule or biopolymer, an organic polymer, a thermoplastic, a wax, a metal, or a combination thereof.

Turning again to additional details of methods described herein for forming the second mold, in some cases, solidifying the second fluid material on the surface of the solidified object to form a second mold of the solidified object may comprise cooling the second fluid material to form a second mold of the solidified object. In some such cases, cooling the second fluid material to form a second mold of the solidified object may comprise cooling the entire chamber or other environment of the second fluid material, including to a temperature that is equal to or lower than freezing point of the second fluid material. In some implementations, cooling the second fluid material to form a second mold of the solidified object may comprise cooling the second fluid material to form a second mold of the solidified object at a temperature between −90° C. and −40° C., between −40° C. and 0° C., between 0° C. and 4° C., between 4° C. and 20° C., between 20° C. and 40° C., or between 40° C. and 65° C. for 10 minutes-20 minutes, 20 minutes-1 hour, 1 hour-2 hours, 2 hours-6 hours, 6 hours-12 hours, 0.5-1 day, 1-5 days, or 1-3 days. Other methods for solidifying the second fluid material on an exterior surface of the solidified object may also be used, and the specific technique used in a given instance is not particularly limited. Moreover, it is to be understood that, in some cases, the second fluid material may be a material that can be applied as a liquid to the solidified object and can solidify around the solidified object without altering the solidified object, particularly without altering the size or shape of the exterior surface of the solidified object.

### II. Three-Dimensional Articles

In another aspect, 3D articles are described herein. In some embodiments, a 3D article (e.g., the solidified object) is formed by a method described herein above in Section I using a first mold. Moreover, in some cases, a second mold is formed using a method described herein above in Section I. In some implementations, a 3D article described herein is formed using any method or system described herein.

A 3D article formed by a method or by a system described herein can have any size, shape, and composition not inconsistent with the objectives of the present disclosure, and these features are not particularly limited. In some cases, a 3D article described herein may comprise an artificial tissue, an artificial organ, a tissue model, a phantom, a stent, or a vascular cast. In some embodiments, a 3D article may define a vascular network or topology. In some implementations, the solidified object may define a vascular network or topology. In some cases, the interior volume of the second mold may define a vascular network or topology, including a vascular network or topology having a size or structure described hereinabove in Section I related to the first mold. As discussed previously, in some embodiments, the vascular network or topology may be configured to facilitate or transport media. In some cases, media may comprise but are not limited to blood, bile, urine, air, or oxygen. Moreover, in some embodiments, more than one vascular network or vascular topology may be incorporated into a solidified article or three-dimensional article. In some implementations, gases and liquids, such as media may be introduced into the vascular network or topology of a solidified article or three-dimensional article.

### III. Systems for Forming a Three-Dimensional Article

In another aspect, systems for forming a three-dimensional article are described herein. In some embodiments, such a system comprises a chamber comprising one or more injection ports, wherein the chamber is pressurized. In some cases, the system further comprises a first mold comprising an interior volume and one or more receiving ports. Any composition for a first mold described hereinabove in Section I may be used. In some implementations, the system further comprises a first fluid material to inject through the one or more injection ports through the one or more receiving ports and into the interior volume of the first mold. Any composition for a first fluid material described hereinabove in Section I may be used.

It is to be understood that in some embodiments, systems described in Section III are to be used with the methods described in Section I. Moreover, it is also to be understood that in some cases, systems described herein are to be used to form 3D articles described in Section II.

### Examples

Some embodiments of compositions for use in a system or method described are illustrated in the following non-limiting Examples. For example, the following non-limiting example compositions may be used to form a mold described hereinabove, such as a first mold or a second mold. Moreover, in some such cases, the following compositions may be formed into a mold by additive manufacturing. Thus, the following example compositions may be considered to be build materials in an additive manufacturing process, as described further herein.

Table 2 provides formulations of non-limiting example build materials according to some embodiments described herein. In Table 2, “Comp.” means “Composition,” and the amounts listed for a given composition are weight percents, based on the total weight of the composition. It is to be understood that all components of a given composition add up to 100 weight percent. Table 3 provides components of Compositions 1-5. Additionally, Table 2 and Table 3 include various abbreviations as follows: “MCM” in refers to monomeric curable material; “QY” refers to quinoline yellow; “E(10)-BPA-DA” refers to ethoxylated (10) bisphenol A diacrylate; “E(30)-BPA-DA” refers to ethoxylated (30) bisphenol A diacrylate; “HPA” refers to hydroxypropyl acrylate; “BEA” refers to 2-carboxyethyl acrylate; “AA” refers to acrylic acid; and “HEAA” refers to hydroxyethyl acrylamide.

TABLE 2
Example Compositions.

| Component | Comp. 1 | Comp. 2 | Comp. 3 | Comp. 4 | Comp. 5 |
|---|---|---|---|---|---|
| Formula (I)/(II) | 20-25 | 30-35 | 30-35 | 30-35 | 15-20 |
| MCM | 40-45 | 30-35 | 30-35 | 30-35 | 30-35 |
| Acrylate or | 30-35 | 30-35 | 30-35 | 30-35 | 45-50 |
| Acrylamide Component | | | | | |
| Photoinitiator | 1-3 | 1-3 | 1-3 | 1-3 | 1-3 |
| Colorant | 0.1-1 | 0.1-1 | 0.1-1 | 0.1-1 | 0.1-1 |

TABLE 3
Example Components.

| Component | Comp. 1 | Comp. 2 | Comp. 3 | Comp. 4 | Comp. 5 |
|---|---|---|---|---|---|
| Formula (I)/(II) | MA- | MA- | MA- | MA- | MA- |
| | PEG200-MA | PEG200-MA | PEG200-MA | PEG200-MA | PEG200-MA |
| MCM | E(10)-BPA- | E(10)-BPA- | E(10)-BPA- | E(10)-BPA- | E(10)-BPA- |
| | DA + E(30)- | DA + E(30)- | DA + E(30)- | DA + E(30)- | DA + E(30)- |
| | BPA-DA | BPA-DA | BPA-DA | BPA-DA | BPA-DA |
| Acrylate or | HPA | HPA + BEA | BEA | BEA + AA | BEA + HEAA |
| Acrylamide Component | | | | | |
| Photoinitiator | TPO-L | TPO-L | TPO-L | TPO-L | TPO-L |
| Colorant | QY | QY | QY | QY | QY |

Printed articles from the Compositions 1, 3, and 5 were tested using ASTM D638 to determine Young's Modulus of each Composition. The results are shown in Table 4.

TABLE 4
Young's Modulus for Example Compositions.

| Composition | Young's Modulus (kPa) |
|---|---|
| Composition 1 | 6,000 |
| Composition 3 | 122 |
| Composition 5 | 127,000 |

Discs of printed articles of Compositions 1-5 with a mass of 0.2 g were submerged in 20 g of an aqueous solution of 6 M NaOH in 30% glycerol. At each hour for 8 hours, the disc was removed from the aqueous solution and patted dry, and the diameter and height of the disc was measured to determine the total volume of the disc. The change in volume of the disc at each hour was averaged over the time course to determine the average rate of degradation for each composition. The average rate of degradation in shown in Table 5.

TABLE 5
Average Rate of Degradation for Example Compositions.

| Composition | Average Rate of Degradation (mm³) |
|---|---|
| Composition 1 | 9.3 |
| Composition 2 | 13.2 |
| Composition 3 | 14.7 |
| Composition 4 | 13.2 |
| Composition 5 | 15.2 |

The foregoing example Compositions were or could be used to form a first mold by additive manufacturing, such a first mold corresponding to the embodiment of FIG. 2.

Some additional non-limiting example Embodiments are as follows.

Embodiment 1. A method of forming a three-dimensional article, the method comprising:
providing a first mold, wherein the first mold comprises an interior volume;
injecting a first fluid material into the interior volume of the first mold; and
solidifying the injected first fluid material within the interior volume of the first mold to form a solidified object.

Embodiment 2. The method of Embodiment 1 further comprising:
forming the first mold by additive manufacturing.

Embodiment 3. The method of Embodiment 1 or Embodiment 2, wherein the first mold is formed from a wax.

Embodiment 4. The method of Embodiment 1 or Embodiment 2, wherein the first mold is formed from a hydrogel.

Embodiment 5. The method of Embodiment 4, wherein the hydrogel comprises: a compound having the structure of Formula (I) or Formula (II):

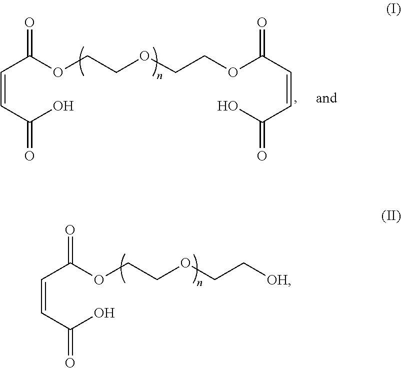

wherein n is an integer between 4 and 40, and
wherein the compound having the structure of Formula (I) and/or Formula (II) is present in an amount of 10-35 wt. %, based on the total weight of the composition; and
a monomeric curable material having the structure of Formula (III):

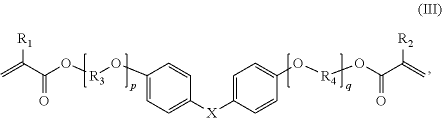

wherein the sum of p and q is an integer between 2 and 30,
wherein R₁ and R₂ are each independently H or CH₃,
wherein R₃ and R₄ are each independently a C₁-C₄ alkyl, and
wherein X is a linear or branched C₁-C₄ alkyl or a group with the structure:

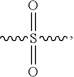

wherein [symbol] represents a point of attachment to the remainder of the structure of Formula (III).

Embodiment 6. The method of Embodiment 5, wherein X is C(CH₃)₂.

Embodiment 7. The method of Embodiment 5, wherein X is CH₂.

Embodiment 8. The method of Embodiment 5, wherein X is a group with the structure:

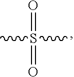

wherein [symbol] represents a point of attachment to the remainder of the structure of Formula (III).

Embodiment 9. The method of any of Embodiments 5-8, wherein the monomeric curable material is present in an amount of 30-50 wt. %, based on the total weight of the hydrogel.

Embodiment 10. The method of any of Embodiments 5-9, wherein the hydrogel further comprises an acrylate or acrylamide component.

Embodiment 11. The method of Embodiment 10, wherein the acrylate or acrylamide component is present in an amount of 25-50 wt. %, based on the total weight of the hydrogel.

Embodiment 12. The method of Embodiment 10 or Embodiment 11, wherein the acrylate or acrylamide component comprises one or more (meth)acrylates.

Embodiment 13. The method of Embodiment 12, wherein the one or more (meth)acrylates comprises carboxyethyl acrylate, hydroxypropyl acrylate, acrylic acid, or a mixture thereof.

Embodiment 14. The method of Embodiment 10, wherein the acrylate or acrylamide component comprises one or more acrylamides.

Embodiment 15. The method of Embodiment 14, wherein the one or more acrylamides comprises dimethyl acrylamide, diethyl acrylamide, acryloyl morpholine, isopropyl acrylamide, dimethyl aminopropyl acrylamide, dimethyl aminopropyl acrylamide, hydroxyethyl acrylamide, or a mixture thereof.

Embodiment 16. The method of Embodiment 14 or Embodiment 15, wherein the one or more acrylamides are present in an amount of 10-40 wt. %, based on the total weight of the hydrogel.

Embodiment 17. The method of any of Embodiments 5-16, wherein the hydrogel further comprises a photoinitiator component.

Embodiment 18. The method of Embodiment 17, wherein the photoinitiator component is present in an amount of 0.1-3 wt. %, based on the total weight of the hydrogel.

Embodiment 19. The method of any of Embodiments 1-18, wherein: the interior volume of the first mold has a vascular topology formed from one or more tubular structures; and
the tubular structures have an average diameter of 1-30 mm, 1-25 mm, 1-20 mm, 1-15 mm, 1-10 mm, 1-5 mm, 5-900 μm, 5-700 μm, 5-500 μm, 5-300 μm, 5-100 μm, 5-50 μm, 10-500 μm, 10-300 μm, 10-100 μm, 10-50 μm, 50-500 μm, 50-300 μm, or 50-100 μm.

Embodiment 20. The method of any of the preceding Embodiments, wherein the first fluid material comprises a biomolecule or biopolymer, an organic polymer, a thermoplastic, a wax, a metal, or a combination of two or more of the foregoing.

Embodiment 21. The method of any of the preceding Embodiments, further comprising removing the first mold from the solidified object.

Embodiment 22. The method of Embodiment 21, wherein removing the first mold from the solidified object comprises dissolving the first mold.

Embodiment 23. The method of Embodiment 21 or Embodiment 22 further comprising modifying an exterior surface of the solidified object.

Embodiment 24. The method of Embodiment 23, wherein modifying the exterior surface of the solidified object comprises roughening or smoothing the surface of the solidified object, coating the exterior surface of the solidified object, or any combination thereof.

Embodiment 25. The method of any of Embodiments 21-24, further comprising:
applying a second fluid material to the exterior surface of the solidified object; and
solidifying the second fluid material on the exterior surface of the solidified object to form a second mold of the solidified object.

Embodiment 26. The method of Embodiment 25, further comprising:
removing the solidified object from the second fluid material to provide a second mold of the solidified object comprising an interior volume.

Embodiment 27. The method of any of the preceding Embodiments, wherein: providing the first mold comprises placing the first mold in a chamber;
the chamber comprises one or more injection ports for injecting the first fluid material into the interior volume of the first mold;
the first mold comprises one or more receiving ports for receiving the first fluid material into the interior volume of the first mold, from the one or more injection ports of the chamber;
injecting the first fluid material into the interior volume of the first mold comprises injecting the first fluid material through the one or more injection ports of the chamber and through the one or more receiving ports of the first mold; and
the method further comprises pressurizing the chamber prior to injecting the first fluid material into the interior volume of the first mold.

Embodiment 28. The method of Embodiment 27, wherein pressurizing the chamber comprises pressurizing the chamber to a pressure greater than 1 atm.

Embodiment 29. The method of Embodiment 27, wherein pressurizing the chamber comprises pressurizing the chamber to a pressure greater than an injection pressure of the first fluid material into the interior volume of the first mold.

Embodiment 30. The method of Embodiment 28 or Embodiment 29, wherein pressurizing the chamber comprises pressurizing the chamber to a pressure less than a crack pressure threshold of the first mold.

Embodiment 31. The method of any of the preceding Embodiments, wherein solidifying the injected first fluid material within the interior volume of the first mold to form the solidified object comprises cooling the first fluid material within the interior volume of the first mold to form the solidified object.

Embodiment 32. The method of any of the preceding Embodiments, wherein the solidified object defines a vascular network or topology.

Embodiment 33. A three-dimensional article formed from the method of any of Embodiments 1-32.

Embodiment 34. A system for forming a three-dimensional article, the system comprising:
a chamber comprising one or more injection ports;
a first mold comprising an interior volume and one or more receiving ports; and
a first fluid material to inject through the one or more injection ports through the one or more receiving ports and into the interior volume of the first mold, wherein the chamber is pressurized.

All patent documents referred to herein are incorporated by reference in their entireties. Various embodiments of the invention have been described in fulfillment of the various objectives of the invention. It should be recognized that these embodiments are merely illustrative of the principles of the present invention. Numerous modifications and adaptations thereof will be readily apparent to those skilled in the art without departing from the spirit and scope of the invention.

1. A method of forming a three-dimensional article, the method comprising:
providing a first mold, wherein the first mold comprises an interior volume;
injecting a first fluid material into the interior volume of the first mold; and
solidifying the injected first fluid material within the interior volume of the first mold to form a solidified object,
wherein the first mold is formed from a hydrogel, and
wherein the hydrogel comprises:
a compound having the structure of Formula (I) or Formula (II): 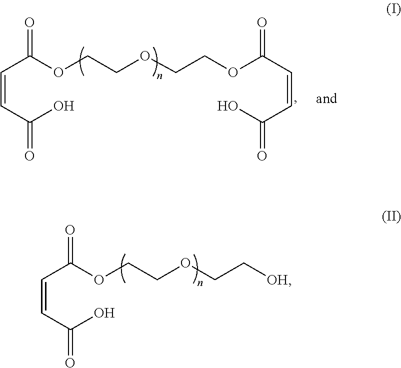
wherein n is an integer between 4 and 40, and
wherein the compound having the structure of Formula (I) and/or Formula (II) is present in an amount of 10-35 wt. %, based on the total weight of the composition; and
a monomeric curable material having the structure of Formula (III): 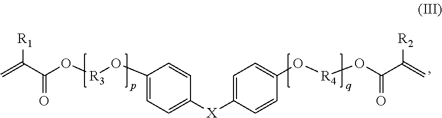
wherein the sum of p and q is an integer between 2 and 30,
wherein R₁ and R₂ are each independently H or CH₃,
wherein R₃ and R₄ are each independently a C₁-C₄ alkyl, and
wherein X is a linear or branched C₁-C₄ alkyl or a group with the structure: 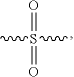
wherein [symbol] represents a point of attachment to the remainder of the structure of Formula (III).

2. The method of claim 1, wherein the monomeric curable material is present in an amount of 30-50 wt. %, based on the total weight of the hydrogel.

3. The method of claim 1, wherein the hydrogel further comprises an acrylate or acrylamide component.

4. The method of claim 3, wherein the acrylate or acrylamide component is present in an amount of 25-50 wt. %, based on the total weight of the hydrogel.

5. The method of claim 3, wherein the acrylate or acrylamide component comprises one or more (meth)acrylates.

6. The method of claim 3, wherein the acrylate or acrylamide component comprises one or more acrylamides.

7. The method of claim 6, wherein the one or more acrylamides are present in an amount of 10-40 wt. %, based on the total weight of the hydrogel.

8. The method of claim 1, wherein:
the hydrogel further comprises a photoinitiator component; and
the photoinitiator component is present in an amount of 0.1-3 wt. %, based on the total weight of the hydrogel.

9. The method of claim 1 further comprising:
forming the first mold by additive manufacturing.

10. The method of claim 1, wherein:
the interior volume of the first mold has a vascular topology formed from one or more tubular structures; and
the tubular structures have an average diameter of 1-20 mm.

11. The method of claim 1, wherein:
the interior volume of the first mold has a vascular topology formed from one or more tubular structures; and
the tubular structures have an average diameter of 50-300 km.

12. The method of claim 1, wherein the first fluid material comprises silk, silk (meth)acrylate, silk (meth)acrylamide, or thiolated silk.

13. The method of claim 1 further comprising:
removing the first mold from the solidified object.

14. The method of claim 13, wherein removing the first mold from the solidified object comprises dissolving or dispersing the first mold.

15. The method of claim 14, wherein the first mold is dissolved or dispersed using aqueous sodium hydroxide.

16. The method of claim 13, further comprising:
applying a second fluid material to the exterior surface of the solidified object; and
solidifying the second fluid material on the exterior surface of the solidified object to form a second mold of the solidified object.

17. The method of claim 16, further comprising:
removing the solidified object from the second fluid material to provide a second mold of the solidified object comprising an interior volume.

18. The method of claim 1, wherein:
providing the first mold comprises placing the first mold in a chamber;
the chamber comprises one or more injection ports for injecting the first fluid material into the interior volume of the first mold;
the first mold comprises one or more receiving ports for receiving the first fluid material into the interior volume of the first mold, from the one or more injection ports of the chamber;
injecting the first fluid material into the interior volume of the first mold comprises injecting the first fluid material through the one or more injection ports of the chamber and through the one or more receiving ports of the first mold;
the method further comprises pressurizing the chamber prior to injecting the first fluid material into the interior volume of the first mold; and
pressurizing the chamber comprises pressurizing the chamber to a pressure greater than an injection pressure of the first fluid material into the interior volume of the first mold.

19. The method of claim 1, wherein solidifying the injected first fluid material within the interior volume of the first mold to form the solidified object comprises cooling the first fluid material within the interior volume of the first mold to form the solidified object.
